(19) United States
(12) Patent Application Publication
(10) Pub. No.: US 2003/0032560 A1
(43) Pub. Date: Feb. 13, 2003

(54) Superconducting article having low AC loss

(76) Inventors: Alexander Otto, Chelmsford, MA (US); Jeffrey D. Schreiber, Middleton, MA (US); Ronald D. Parrella, Holden, MA (US); Jennifer H. Garrant, Natick, MA (US)

Correspondence Address: HALE AND DORR, LLP, 60 STATE STREET, BOSTON, MA, 02109

(21) Appl. No.: 09/954,317

(22) Filed: Sep. 17, 2001

Related U.S. Application Data
(60) Provisional application No. 60/232,732, filed on Sep. 15, 2000.

(51) Int. Cl. H01B 1/00

(52) U.S. Cl. 505/100

(57) ABSTRACT

A multifilamentary superconducting composite article includes a plurality of oxide superconducting filaments in a ductile metal matrix arranged about a central core, and a region of high resistivity embedded within and adherent to the metal matrix and substantially surrounding each oxide superconducting filament. The high resistivity region is perforated and the perforation is occupied by a material having a bulk material resistivity greater than 0.4 μ-cm. The article demonstrates a filament to filament resistance greater than 1×10⁻⁶ ohm-cm at T>T_{c}, where resistance is the four-point transport resistance between filaments multiplied by the measured sample length The ac power loss in a field perpendicular to the strand surface or in any other orientation is less than 2.5 mW/A-m at greater than 10 mT (RMS ac field, 30-300 Hz), as measured by magnetic methods without transport current. Methods of manufacture are provided.

### CROSS REFERENCE TO RELATED APPLICATIONS

This application is related to co-pending application entitled “Oxide Superconductor Composite Having Smooth Filament-Silver Interface” filed on even date herewith.

This application is related to copending application entitled “Filaments for Composite Oxide Superconductors” filed on even date herewith.

This application is a continuation-in-part application of and claims priority under 35 U.S.C. § 119(e) from U.S. Ser. No. 60/232,732 filed Sep. 15, 2000, and entitled “Superconducting Article Having Low Ac Loss.”

All applications are hereby incorporated in their entirety by reference.

### BACKGROUND OF THE INVENTION

This invention relates to superconducting oxide articles having improved characteristics for alternating current (ac) and time varying magnetic field operation and to a method for manufacturing them. In particular, the invention relates to composite articles comprising multiple, substantially electrically decoupled domains and to methods and intermediates for manufacturing such composites.

Since the discovery of the first high transition temperature oxide superconductors 13 years ago, there has been great interest in developing high temperature superconducting conductors for use in high current applications such as power transmission cables, motors, magnets and energy storage devices. These applications require wires and tapes with high engineering critical current densities, robust mechanical properties, and long lengths manufacturable at reasonable cost. Superconducting oxide materials alone do not possess the necessary mechanical properties, nor can they be produced efficiently in continuous long lengths. Superconducting oxides have complex, brittle, ceramic-like structures, which cannot by themselves be drawn into wires or similar forms using conventional metal-processing methods. Moreover, they are subject to a magnetic effect known as flux flow and inductor, which lead to extensive energy dissipation, taxing the refrigeration and potentially overheating the conductor. Consequently, the more useful forms of high temperature superconducting conductors usually are composite structures in which the superconducting oxides are supported by a matrix material, which adds mechanical robustness to the composite and provides good thermal dissipation in the event of magnetic field-induced energy dissipation.

Appropriate matrix materials are readily formable, have high thermal conductivity, and are sufficiently non-reactive with respect to the superconducting oxides under the conditions of manufacturing and use that the properties of the latter are not degraded in its presence. For composites made by the popular powder-in-tube or PIT process, described, for example, in U.S. Pat. Nos. 4,826,808, and 5,189,009 to Yurek et al., and W. Gao & J. Vander Sande, Superconducting Science and Technology, Vol. 5, pp. 318-326, 1992; C. H. Rosner, M. S. Walker, P. Haldar, and L. R. Motowidlo, “Status of HTS superconductors: Progress in improving transport critical current densities in HTS Bi-2223 tapes and coils” (presented at conference ‘Critical Currents in High Tc Superconductors,’ Vienna, Austria, April, 1992) and K. Sandhage, G. N. Riley Jr., and W. L. Carter, “Critical Issues in the OPIT Processing of High Jc BSCCO Superconductors”, Journal of Metals, Vol. 43, 21,19, all of which are herein incorporated by reference, the matrix material must also provide sufficient oxygen access during manufacturing to allow the formation of a superconducting oxide from its precursor material.

Under normal manufacturing conditions, superconducting oxides have adverse reactions with nearly all metals except the noble metals. Thus, silver and other noble metals or noble metal alloys are typically used as matrix materials, and pure silver is the matrix material generally preferred for most high performance applications. Composite matrices, including, for example, oxide diffusion barriers and silver layers between superconducting oxides, and non-noble metals matrices have been suggested in the prior art.

Many of the superconductor applications that have the greatest potential for energy conservation involve operating the superconductor in the presence of ramped magnetic field or oscillating (ac) magnetic field, or require that the superconductor carry an alternating current. In the presence of time-varying magnetic fields or currents, there are a variety of mechanisms that give rise to energy dissipation, hereafter called ac losses. Thus, the superconductor geometry and intrinsic properties and composition must be selected and developed to reduce ac losses, in order to preserve the intrinsic advantage of superconductors—the absence of direct current (dc) electrical resistance. The physics governing ac losses in low temperature superconducting composite materials have been described and analyzed, e.g., by C. F. Wilson, Superconducting Magnets, Ch 8 (1983,1990); and W. J. Carr, Jr., Ac Loss And Macroscopic Theory Of Superconductors, Gordon and Breach Science Publishers, New York, 1983, and would be expected to operate in superconducting oxide composites with similar geometries. A discussion of ac losses in high temperature oxide superconductor composite tapes is found in “Electromagnetic interfilament coupling of silver-sheathed Bi-2223 multifilamentary tapes in transverse ac magnetic fields,” Sugimoto et al., Physica C 279:225 (1997), which is hereby incorporated in its entirety by reference.

Ac losses include induced currents flowing in closed loops that arise from time-varying magnetic field changes within these loop areas. Eddy current loops flow within the matrix and are mitigated by a high resistance matrix. Hysteretic losses are current loops within the superconducting material, and are mitigated by reducing the superconducting filament dimension that is orthogonal to the field direction, i.e., the cross-sectional dimension of the filament. Filament coupling losses are current loops that span two or more filaments in a multifilamentary article, and are mitigated by twisting the filament bundle about the conductor axis to reduce loop length, and by introducing high resistance between the filaments.

Conventional methods for increasing the resistivity of the matrix are limited. Silver, the matrix material of choice for these composites, has a very low electrical resistivity. Efforts have been made to increase the resistivity of the matrix, for example, by distributing small amounts of oxide-forming metals in finely separated form in a silver matrix, and by using alloys with higher resistivity than silver to form all or part of the matrix adjacent to the filaments. However, the presence of even very small amounts of chemically reactive materials near the filament/matrix boundary during the manufacturing process can significantly degrade the properties of the superconducting oxide composite or increase the brittleness of the matrix. This is a particularly difficult issue for composites consisting of many fine filaments as the resultant increase in surface to volume ratio greatly increases the risk of contamination. In the powder-in-tube (PIT) manufacturing process, layers of high resistivity material can also block oxygen access to the filaments during manufacturing, inhibiting the formation of the superconducting oxide from its precursors.

A further complication arises in conventional multifilament composite tapes that are high aspect (>8:1) with thin, but wide, filaments. The filaments merge together sporadically due to the combination of rolling deformation used in deformation-induced texturing, filament-filament proximity and oxide superconductor grain growth and melt-assisted sintering employed in the final stages of oxide superconductor formation. If the resistance between filaments is low enough, or the filaments merge frequently enough, a fully-coupled, monofilament-like loss response to ac magnetic field is observed.

Reported approaches to filament decoupling include the use of powder or loosely sintered ceramic layers between oxide superconducting filaments. Such an approach was hoped to serve the dual purpose of electrically decoupling each filament, while providing adequate oxygen diffusivity through the barrier layer. Y. B. Huang and R. Flukiger report the incorporation of oxide powder layers (“Reducing ac losses of Bi(2223) multifilamentary tapes by oxide barriers,” Physica C, 294:71 (1998)) and Eckelmann et al. report the incorporation of carbonate powder layers (Goldacker W., et. al., Physica C 310:182 (1998)) in a silver matrix of a monofilament precursor wire. The oxide particle assemblies were found to co-deform poorly with silver, leading to variable layer thickness, extensive perforations of the ceramic layer and weak decoupling for magnetic fields applied normal to the large plane of the tape (H). A further problem with this approach is that liquid formed in the final heat treatment to assist oxide superconductor sintering is drawn into the porous oxide particle layer by capillary action through breaches in the silver. This locally destroys the chemistry of the oxide superconductor and impairs Jc.

Fully dense, thin ceramic decoupling layers have also been considered for the electrical isolation of filaments to avoid problems associated with capillary interaction with the oxide superconductor filament during reaction. Published International Application No. WO 96/36485 describes a multifilamentary superconducting composite having multifilamentary domains separated by high resistivity insulating material. The insulating material is initially positioned in the composite as metal sheets or foils, which are then converted into a high resistance material that serves as the decoupling layer. The geometries (positioning of the metal layers relative to the superconducting domains) are complex—all the more so when it is desired to electrically decouple each individual oxide superconducting filament. In order to ensure that the composite co-deforms well with the silver matrix during processing of these complex geometries into the final oxide superconductor, the decoupling layer must be well-adhered to the metal matrix. However, the composites disclosed in WO 96/36485 do not provide the requisite strong decoupling layer/metal matrix interface, leading to filament non-uniformity and extensive perforation of the decoupling layer. This is exacerbated further when the multifilamentary composite is combined into a cable.

Published International Application WO 96/28853 describes a composite oxide filament having a metal oxide layer surrounded by a conductive metal sheath. The composite is prepared from an oxidizable metal, which forms the metal oxide layer after the composite has been plastically deformed into its desired final state. The metal oxide layer includes pores as a result of sheath thinning during processing, which permit oxygen diffusion. The resultant pores impair the electrical insulating effect of the metal oxide layer. Loss measurements of composite article prepared by this method have been disappointing. See, for example, Flükiger et al.

Thus, the improvements in ac losses reported to date are minor in comparison to what is required for practical applications in which the conductor is subjected to time-varying magnetic fields at many field orientations.

### SUMMARY OF THE INVENTION

The present invention relates to an oxide superconducting composite and oxide superconducting cable which overcome these and other limitations of the prior art to provide composite conductors having high J_{c} and/or Jₑ and low ac losses when subjected to time-varying magnetic fields at many field orientations. In particular, the invention provides an oxide superconductor composite and oxide superconductor cable having high interfilament resistivity and high oxygen diffusivity through the metal matrix.

In one aspect of the invention, an oxide superconducting composite of the invention is capable of electrically isolating individual superconducting oxide filaments, while retaining sufficiently low longitudinal resistivity in contact with the superconducting filament to serve as a conductive shunt, supporting adequate oxygen diffusity within the composite to permit formation and retention of a high quality oxide superconductor phase, and demonstrating high filament-to-filament resistivity, while maintaining high current carrying capability, i.e., high Jₑ. High Jₑ is a function of the quality of the oxide superconductor phase.

A further aspect of the invention is an oxide superconductor cable prepared from the electrically decoupled oxide superconducting composition of the invention having the mechanical robustness necessary to survive processing into a cabled conductor, and having relatively low aspect superconducting strands suitable for cabling, for example, less than 4:1 in cross-section shape aspect.

Improved methods of cabling are also provided, which retain oxide superconductor physical integrity and electrical transport properties during the demanding steps of cabling brittle oxide filaments.

In one aspect of the invention, a multifilamentary superconducting composite article includes a plurality of peripherally arranged oxide superconducting filaments in a conductive, ductile metal matrix. The filaments are arranged about an optional central core. A plurality of high resistivity regions are embedded within and adherent to the conductive metal matrix such that a high resistivity region substantially surrounds each oxide superconducting filament. Each high resistivity region is made up of a high resistivity material having a bulk resistivity greater than 0.4 μΩ-cm interdispersed with bridges of a material having a resistivity intermediate to those of the conductive metal matrix and the high resistivity material.

The composite conductor demonstrates a sufficiently high resistivity region and low incidence of filament merging to provide a filament-to-filament resistance greater than 1×10⁻⁶ ohm-cm, where resistance is the four-point transport resistance between filaments multiplied by the measured sample length.

In at least some embodiments, the composite conductor demonstrates sufficiently high resistivity in the high resistivity region, high DC or AC electrical transport of the oxide filaments and low incidence of filament merging to reduce ac losses to less than 5 mW/A-m, preferably less than 3 mW/A-m and more preferably less than 2 mW/A-m, in a conductor with a self field I_{c} (at 77K) of greater than 2A, more preferably greater than 5 A, and most preferably greater than 20 A, and a field ramp rate of greater than 0.1 T/s, preferably greater than 1 T/s, and most preferably greater than 5 T/s, as measured by magnetic methods without transport current.

Of particular utility are loss levels no greater than about 0.05 W/cm³ at the operating conditions for superconducting transformers, which typically involve ac magnetic fields with components oriented both in the direction of and orthogonal to the high current direction of the conductor, at average field change rates greater than 0.1 T/second and, for transformers, up to ˜10 T/second.

In at least some embodiments, the article demonstrates a filament to filament resistance greater than 1×10⁻⁶ ohm-cm at T<T_{c}, where resistance is the four-point transport resistance between filaments multiplied by the measured sample length.

In at least some embodiments, the ac power loss in a field perpendicular to the strand surface is less than 2.5 mW/A-m at greater than 0.01 T (RMS ac field, 30-300 Hz), as measured by magnetic methods without transport current.

In at least some embodiments, energy loss is less than 2.5 mW/A-m in a changing magnetic field at greater than 0.5 T/s, regardless of field orientation, as measured by magnetic methods without transport current.

In at least some embodiments, the article has a cross-sectional width in the range of 100-1500 μm and a cross-sectional thickness in the range of 30-500 μm, or the article has a cross-sectional width less than 300 μm and a cross-sectional thickness less than 100 μm. In at least some embodiments, the distance between oxide superconductor filaments is in the range of 10-100 μm.

In at least some embodiments, the oxide superconducting filaments are arranged about a central core selected from the group consisting of an electrically resistive core and an oxide superconductor core. In at least some embodiments, the oxide superconductor filaments are arranged in a single concentric layer about the central core or are arranged in two or more concentric layers about the central core.

In at least some embodiments, the bridges comprise less than or equal to 20% vol/vol of the high resistivity region, or the bridges comprise less than or equal to 10% vol/vol of the high resistivity region. In at least some embodiments of the invention, the bridges make up at least 0.001 % vol/vol of the high resistivity region, or the bridges make up at least 1.0 % vol/vol of the high resistivity region.

In at least some embodiments, the conductive matrix metal includes silver and the material occupying the bridges of the high resistivity region include oxide dispersion strengthened (ODS) silver. In other embodiments, the conductive matrix metal comprises ODS silver and the material occupying the bridges of the high resistivity region include an ODS silver of higher resistivity. The oxide of the ODS silver may be selected from the group consisting of Al, Mg, Ti, Si, Co, Ni, Zr, Hf and rare earth elements, and the oxides may be present in a volume % in the range of up to 5.0.

In at least some embodiments, the high resistivity material of the high resistivity region includes a simple or complex oxide selected from the group consisting of nickel, lead, ytterbium, aluminum, copper and calcium. The high resistivity region has a thickness in the range of 0.1 to 2 microns.

In at least some embodiments, the high resistivity region is in the form of a closed surface about the oxide superconducting filament. In yet another embodiment, the high resistivity region is in the form of a sheet spirally wrapped around the oxide superconducting filament. In preferred embodiments, the high resistivity region has a honeycomb structure in which the high resistivity material comprises the honeycomb and the bridges occupy the spaces between the honeycomb.

In at least some embodiments, the article is comprised of 3-1000 oxide superconducting filaments, or 3-100 oxide superconducting filaments, or preferably 6-18 oxide superconducting filaments. The oxide superconductor filaments may have a cross-sectional aspect ratio of less than 8:1, or the oxide superconductor filaments have a cross-sectional aspect ratio of about 2:1 to about 5:1.

In at least some embodiments, the article has a Jₑ of at least 3 kA/cm², self-field at 63 K, or preferably at least 5 kA/cm², self-field at 63 K, or of at least 8 kA/cm², self-field at 63 K.

In at least some embodiments, the plurality of filaments are twisted about a longitudinal axis of the article. In at least some embodiments of the invention, the twist pitch is in the range of 0.2 to 20 cm, or in the range of 0.2 to 3 cm.

In at least some embodiments, the oxide filament substantially surrounded by the high resistivity region does not merge with its neighboring filaments more frequently than once every twist pitch, or more frequently than once every two twist pitches.

In at least some embodiments, the article includes an outer high resistance layer substantially surrounding the outermost surface of the composite article. The article may further include a layer of material surrounding the outer high resistance layer, said material capable of bonding to similar materials, e.g., silver.

In another aspect of the invention, a multifilamentary composite article serving as a precursor to an oxide superconductor includes a plurality of oxide filaments in a ductile metal matrix, said oxide comprising an oxide superconductor or precursor thereto, and a plurality of regions comprised of a predecessor metal to a high resistivity material embedded in and adherent to the metal matrix, and wherein a predecessor metal region substantially surrounds each oxide filament. The predecessor metal has a plasticity on the order of the ductile matrix metal.

In at least some embodiments, the predecessor metal is selected from the group consisting of aluminum, copper, nickel ytterbium, lead, calcium, and alloys thereof, or preferably is high purity aluminum and alloys thereof.

In at least some embodiments, the alloying metal is selected from the group consisting of Li, Na, K, Mg, Cu, Ca, Si and Mn, in which the alloying addition is present in an amount less than 5 wt %. The predecessor metal region may include a mixture or alloy of a metal and a fine particle ceramic. In preferred embodiments, the predecessor metal region includes a metal mixture or alloy in a stoichiometry to form a complex oxide upon oxidation and reaction, e.g., a blend, mixture or alloy of barium and/or strontium with ZrO₂. In other preferred embodiments, the predecessor metal region comprises layers of different metals, wherein each layer of a thickness that provides a stoichiometry of a complex metal oxide. In other preferred embodiments, the region includes at least three metal layers and a metal more reactive to silver is sandwiched between layers of less reactive metal. One or more metal elements of the high resistivity material may be alloyed or mixed with the metal matrix.

In another aspect of the invention, a multifilamentary superconducting composite cable includes a plurality of strands transposed about a longitudinal axis. Each strand includes a plurality of oxide superconducting filaments in a conductive, ductile metal matrix arranged about a central core and a plurality of high resistivity regions embedded within and adherent to the conductive metal matrix. A high resistivity region substantially surrounds each oxide superconducting filament. Each high resistivity region includes a substantially continuous phase of a high resistivity material having a bulk resistivity greater than 0.4 μΩ-cm interdispersed with bridges of a material having a resistivity intermediate to those of the conductive metal matrix and the high resistivity material.

In at least some embodiments, the strands are transposed about a high resistance core. In other preferred embodiments the core is in the form of an elongated tape having periodic regions of wider and narrower width.

In at least some embodiments, the cable is an aspected tape having 2 filament height and n filaments across, where n is in the range of 2 to 20. The cable may include two or more strands or, in at least some embodiments, up to 500 strands. In at least some embodiments, each strand contains of 6-18 oxide superconducting filaments.

In at least some embodiments, the strands of the cable further comprise a high resistance layer substantially surrounding the outermost surface of the strands. In one embodiment, the bridges comprise a dispersed oxide-metal alloy.

In at least some embodiments, the cable has a cross-sectional aspect ratio of less than 10:1, or less than 4:1.

In at least some embodiments, the cable has a Jₑ of at least 2 KA/cm², self field at 77 K. In another embodiment, the cable has an ac power loss in a field perpendicular to the strand of less than 5 mW/A-m at greater than 10 mT (RMS ac field, 30-300 Hz), as measured by magnetic methods without transport current. In still another embodiment, the cable exhibits I_{c} of at least 20, at least 50, or at least 100A, self field at 77 K, 1 μV/cm. In another embodiment, the cable demonstrates a filament to filament resistance greater than 1×10⁻⁶ ohm-cm at T<T_{c}, where resistance is the four-point transport resistance between filaments multiplied by the measured sample length. In still another embodiment, the cable demonstrates a strand to strand resistance greater than 1×10⁻⁶ ohm-cm at T<T_{c}, where resistance is the four-point transport resistance between filaments multiplied by the measured sample length.

In another aspect of the invention, a method of making a multifilamentary superconducting composite article includes forming an elongated multifilamentary composite having a plurality of oxide filaments in a ductile metal matrix in which the oxide includes an oxide superconductor or precursor thereto, and a plurality of regions including a predecessor metal to a high resistivity material embedded in and adherent to the metal matrix, and substantially surrounding each said oxide filament. The predecessor metal region has a plasticity on the order of the ductile matrix metal. The composite is then processed to reduce composite cross-sectional area and to induce texture in the precursor oxide filaments under conditions which substantially prevent oxidation of the predecessor metal and which maintain the physical integrity of the predecessor metal within the sheath. The textured composite is then oxidized to form a high resistivity material. The precursor oxide is then converted into an oxide superconductor, whereby a multifilamentary composite comprising a region of high resistivity embedded within and adherent to the metal matrix and substantially surrounding each oxide superconducting filament is obtained.

In at least some embodiments, the step of forming an elongated multifilamentary composite includes applying a layer of predecessor metal to a metal matrix core, introducing a metal matrix sheath around the predecessor metal layer to form a core/metal layer/sheath composite, and co-deforming the composite under conditions, which do not oxidize the predecessor metal.

In at least some embodiments, the predecessor metal is in the form of a foil. In another embodiment, the predecessor metal is deposited by electroplating or electrodeposition. The core may be solid or hollow.

In at least some embodiments, the composite is textured by a large reduction rolling on the order of 40-85% reduction in thickness, or is textured in a constrained rolling operation. In other embodiments, the oxidized composite is subjected to a low strain deformation operation after oxidation of the predecessor metal in the range of 0-15% reduction in thickness, selected so that the physical integrity of the oxidized predecessor metal layer is not destroyed.

In another aspect of the invention, a former for use in a multistrand cable is provided as a flattened strip of resistive material or a predecessor thereto, the strip having curved edges.

In another aspect of the invention, a monofilament rod for use in preparing a multifilament oxide superconducting strand is provided which includes an oxide filament in a ductile metal matrix, wherein the rod has a cross-sectional shape comprising two opposing curved surfaces connected by two substantially planar surfaces. The oxide includes an oxide superconductor or precursor thereto.

By “interfilament resistance” or “filament-to-filament resistance,” as those terms are used herein, is meant the measured resistance experienced in a multifilamentary article when current flows from one filament to another. This can be measured using standard four-point probe methods on samples with polished ends, or by analysis of loss data.

By “high resistivity region,” as the term is used herein, is meant discrete layers or regions comprising relatively insulating materials or their predecessors, which are embedded in the ductile metal matrix and which substantially surround each superconducting filament. Typically the high resistivity regions extend parallel to the filaments along the length of the article, and are very thin in proportion to their width and length. In cross-section they may completely surround and enclose the filament, so as to define a closed circle, oval, square, rectangle, or other closed polygonal or curvilinear shape. Alternatively, the high resistivity region may surround, but not enclose the superconducting filament. Thus, in cross-section the high resistivity region forms an open geometry, such as a spiral, around the filament that is interdispersed with a metal matrix. Such an architecture is referred to as a “jelly roll” configuration. The high resistivity layer may also take on a grain boundary decorating configuration, in which the high resistivity material appears to surround the perimeter of matrix metal grains in a confined region. Since a material having a high resistivity gives rise to high resistance, the terms high resistivity material and high resistance material sometimes may be used interchangeably.

The term “bridge” is used herein to define an area within the high resistivity region that possesses a resistivity intermediate to those of the conductive metal matrix and high resistance material. In addition, the bridges are made up of a material or materials that have high oxygen transport properties. The position and amount of bridges in the high resistivity region is selected to provide a balance between the need for oxygen transport through the matrix and the need to maintain a continuous, high resistance within the high resistance region. The bridges preferably are located so as to provide a continuous pathway through the high resistivity region and span areas of high resistance material, so that substantially the entirety of the high resistivity region has a resistance greater than the surrounding metal matrix.

By “high resistivity,” as that term is used herein, is meant a material with an intrinsic resistivity that is high in comparison to that of the matrix material used in the composite under the intended conditions of use. Materials with bulk or intrinsic resistivities of greater than 2 μΩ-cm, and preferably greater than 20 μΩ-cm may be used, and materials with resistivities greater than about 100 μΩ-cm are more preferred. The material should not have such a high resistivity, nor should the layer be of a thickness or density, which substantially eliminates current sharing between filaments. This condition is furthered by the use of bridges in the high resistivity region of intermediate resistivity.

By “predecessor metal or material,” as that term is used herein, is meant a material that can be converted into the high resistivity material of the oxide superconducting article by heat treatment under suitable conditions. Metals that form dense, continuous thin oxide layers are preferred. In addition, as is discussed in detail in the following description, the metal preferably has deformation properties similar to the metal matrix.

By “adherent,” as that term is used herein, is meant a metallurgical bond between the components of the article. A metallurgical bond is one in which the bond between two materials forms an interface that is free of voids, contaminating films, or discontinuities. Contact and bonding between the two materials is on an atomic level.

By “matrix,” as that term is used herein, is meant a material or homogeneous mixture of materials which supports or binds a substance, specifically including the filaments, disposed within the matrix. By “noble metal,” as that term is used herein, is meant a metal which is substantially non-reactive with respect to oxide superconductor and precursors and to oxygen under the expected conditions (temperature, pressure, atmosphere) of manufacture and use. Silver, gold, platinum and palladium are typical noble metals. “Alloy” is used herein to mean an intimate mixture of substantially metallic phases or solid solution of two or more elements. Silver and other noble metals are preferred matrix materials. In particular, silver-containing dispersed metal oxides (oxygen-dispersion strengthened or ODS silver), which increase the toughness and resistivity of the matrix, are preferred.

By “desired oxide superconductor” or “final oxide superconductor,” as those terms are used herein, is meant the oxide superconductor intended for eventual use in the finished article. Typically, the desired oxide superconductor is selected for its superior electrical properties, such as high critical current temperature or critical current density. Members of the bismuth and rare earth families of oxide superconductors are particularly preferred. By “precursor” as that term is used herein, is meant any material that can be converted into a desired oxide superconductor under suitable heat treatment.

### BRIEF DESCRIPTION OF THE DRAWING

The invention is described with reference to the following figures, which are presented for the purpose of illustration only and which are not intended to be limiting of the invention, and in which:

FIG. 1 is a schematic illustration of a transverse cross-section of a multifilamentary strand made in accordance with at least one embodiment of the invention;

FIG. 2 is a schematic illustration of a transverse cross-section of a multifilamentary strand exemplifying an embodiment of the invention;

FIG. 3 is a schematic illustration of a transverse cross-section of a monofilament used in accordance with at least one embodiment of the invention;

FIG. 4 is a pictorial illustration of (A) a high resistance layer containing bridges; and (B) a grain boundary decorated multilaminar high resistance regions containing bridges;

FIG. 5 is a schematic illustration of a transverse cross-section of another preferred embodiment used in accordance with at least one embodiment of the invention;

FIG. 6 is an illustration of a transverse cross-section of a 2×n cable of the invention;

FIG. 7 is a flow diagram illustrating the processing of a multifilamentary strand and cable of the invention;

FIG. 8 is a schematic illustration of a transverse cross-section of a silver core-foil-silver billet composite according to at least one embodiment of the invention;

FIG. 9 is a schematic illustration of the process used to (A) make and (B) consolidate a jelly roll predecessor metal composite;

FIG. 10 is a schematic cross-section illustration of a preferred precursor monofilament geometry (A) prior to bundling, and photomicrographs (B) of a multifilament strand after consolidation and oxidation to form the high resistivity region and (C) after final processing into a textured oxide superconductor;

FIG. 11 is a schematic illustration of a constrained rolling process used in texturing of the composite article in at least one embodiment of the invention;

FIG. 12 is a schematic representation of a cabling machine including an edge bending tool according to at least one embodiment of the invention;

FIG. 13 is (A) a perspective drawing of a former used in preparation of the cable of the invention, and top views of (B) a former used to cable an even number of strands and (C) a former used to cable an odd number of strands;

FIG. 14 is a scanning photomicrograph of a multifilament strand after consolidation;

FIG. 15 is a plot of loss and critical current density Jₑ vs. intermediate rolling strain for 6-filament strands of the invention having an aluminum oxide decoupling layer and a 0.2 wt % Mg-ODS silver sheath;

FIG. 16 is a top view of an edge bending tool used in at least one embodiment of the present invention; and

FIG. 17 is (A) an illustration of the s-curve strand after edge bending and (B) its relationship to the layed-up strand.

### DESCRIPTION OF PREFERRED EMBODIMENTS

In at least some embodiments, the present invention provides an oxide superconducting conductor including a plurality of oxide superconducting filaments in a ductile metal matrix, and a high resistivity region embedded within and adherent to the metal matrix. The high resistivity region substantially surrounds each oxide superconducting filament, so as to provide a high filament-to-filament resistance at operating conditions, for example, greater than or equal to 1×10⁻⁶ ohm-cm. High filament-to-filament resistance is associated with the reduction of ac coupling losses. The composite conductor possesses a sufficiently high interfilament resistance, high dc or ac transport, and sufficiently low incidence of filament merging to reduce ac losses to less than 5 mW/A-m, or, in some embodiments, less than 3 mW/A-m or, in at least some embodiments or, in at least some embodiments, less than or equal to 2 mW/A-m, in a conductor with a self field I_{c} (at 77K) of greater than 2A, or in at least some embodiment, greater than 5 A or, in at least some embodiments, greater than 20 A, and a field ramp rate of greater than 0.1 T/s or, in at least some embodiments, greater than 1 T/s or, in at least some embodiments, greater than 5 T/s, as measured by magnetic methods without transport current.

In at least some other embodiments of the present invention, the superconductor demonstrates ac losses of less than 0.05 W/cm³ or, in at least some embodiments, less than 0.01 W/cm³ at T<T_{c}, Jₒₚ>1000 A/cm² (operating DC or root mean square (RMS) AC current density) and an average magnetic field time rate of change of greater than 0.1 T/s or, in at least some embodiments, greater than 1 T/s or, in at least some embodiments, greater than 5 T/s, maximum magnetic fields of up to 0.025 T or, in at least some embodiments, up to 0.1 T or, in at least some embodiments, up to 10 T. Part of this field may be a static dc-type field with an ac ripple or ramp.

The conductor may be a multifilamentary composite (alternatively referred to as a “strand” or “tape”) or a cable containing a plurality of multifilament composites.

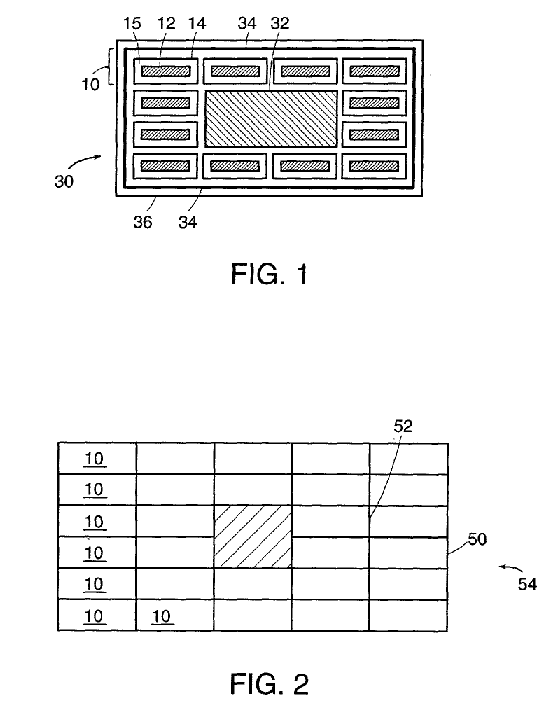

Low ac loss multifilament strands. With reference to FIG. 1, individual composite monofilaments 10 are combined to form a multifilamentary composite 30 having demonstrably lower ac losses and interfilament resistance than has been shown for prior art composites.

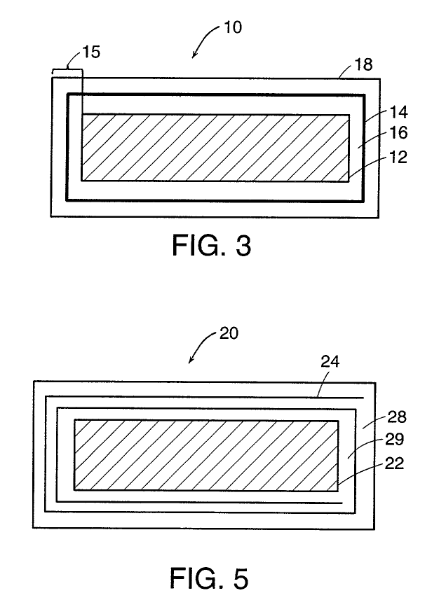

The monofilament 10 may have a variety of architectures. One exemplary monofilament 10 of the composite filament is shown in cross-section in FIG. 3. The composite monofilament includes an oxide superconducting filament 12 in a metal matrix 15. The metal matrix 15 contains a high resistivity layer 14, which substantially surrounds the oxide superconductor filament 12. In at least some embodiments, the high resistance layer 14 forms a closed surface about the superconducting core. The monofilament is aspected to contribute to the overall aspect ratio of the multifilament composite. Low aspect ratio strands and filaments are desirable because the oxide superconductor fill factor is increased and the thickness of the matrix metal and high resistivity layer between each oxide superconductor is more easily maintained. The shape of the individual filaments generally takes on the shape of the overall multifilament composite.

To obtain a multifilamentary composite, a plurality of composite monofilaments 10 (FIG. 3) are arranged concentrically, optionally about a central core 32 (FIG. 1). The monofilaments 10 are consolidated to provide a perimeter ring of oxide superconducting filaments 12 in a metal matrix 15, with each oxide superconducting filament 12 separated from its neighbor by a high resistivity layer 14. The multifilamentary composite typically includes between 2 and 1000 filaments, inclusive. In at least some embodiments of the present invention, there are between 2 and 100 or, in at least some embodiments, between 6 and 18 or, in at least some embodiments, between 6 and 13 filaments per multifilamentary composite. The components of the composite, e.g., monofilaments 10 and core 32, are fully bonded and adherent to form an integral strand.

In at least some embodiments, the center core 32 of each strand 30 is an oxide superconducting monofilament. In at least some other embodiments, it may be a monofilament 10 having a high resistivity layer 14, such as those in the perimeter of the strand. An oxide superconductor monofilament core increases the fill factor of the strand, i.e., the volume of the strand occupied by oxide superconductor material. This results in improvements to both the critical current, I_{c}, and the engineering critical current density, Jₑ, of the strand.

In at least some embodiments, multiple concentric filament rings are possible. The composite may include an outer perimeter filament ring 50 surrounding an inner perimeter filament ring 52 to create a multifilamentary composite 54 as is shown in FIG. 2. The central core may be made of a resistive material or it may be an oxide superconductor monofilament, or it may be an oxide superconductor monofilament having a high resistivity layer.

Use of a resistive core may be desired under conditions for which decoupling is inadequate with the superconductive core. The filament core 32 may consist of a relatively insulating material, which assists in reducing filament-filament coupling losses. The high resistivity core may be made up of the same materials used for the high resistance layers of the composite filaments, or it may be a high resistance metal alloy. It may also be a ceramic material, such as simple or complex metal oxides. Exemplary simple oxide ceramic materials include, but are not limited to, copper oxides, magnesium oxides, strontium oxides, aluminum oxide and the like. Exemplary complex oxides include calcium/strontium plumbates and barium zirconate, and the like. In those instances where a ceramic core is used, it is preferably coated with an outer metallic layer that forms an adherent bond with the individual monofilaments of the multifilamentary composite.

In at least some embodiments, the multifilamentary composite is aspected and has an aspect ratio of about 2:1 to 5:1 or even to 8:1. An aspected strand may be used, as is described herein below, to prepare a multistrand cable. The strands may be of a wide range of sizes depending upon the desired final dimensions of the cable. In at least some embodiments, the strands may be relatively large, e.g., with dimensions of up to 0.15 cm×0.05 cm (cross-sectional area of the strand) or even to 0.5 cm×0.15 cm. In at least some embodiments, the multifilamentary composite may have a cross-sectional width of less than 300 μm and a cross-sectional thickness of less than 100 μm. In at least some embodiments, the distance between oxide superconducting filaments 12, e.g., the thickness of the metal matrix between oxide filaments, is in the range of 10-100 μm. These dimensions have been identified as desirable for the current carrying capacity of the composite, while minimizing filament cross-sectional area that is associated with increased hysteresis loss.

In at least some embodiments, the multifilamentary composite is about 0.01-0.13 cm² in cross-section and has a transverse aspect ratio of about 2:1 to 5:1.

In at least some embodiments of the present invention that are well-suited as low ac loss strands, a transverse aspect ratio of 2:1 to 4:1 may be used, since low aspect strands are easier to cable. About 6 to 12 perimeter oxide superconductor filaments of a cross-section of about 2.5×10⁻⁵ cm²are arranged about a resistive core, e.g., a silver-free resistive density core, and the strand has a twist pitch of about 0.2-3 cm. The engineering critical current Jₑ is greater than about 3000 A/cm² (63K, self field, 1 μv/cm) or, in some embodiments, greater than or equal to about 5000 A/cm or, in some embodiments, greater than or equal to about 8000 A/cm², where Jₑ is the engineering critical current density determined by the total current over the cross-sectional area of the entire strand. The operating critical current density Jₒₚ is greater than 3 kA/cm², where Jₒₚ is the operating current density (at ac field, temperature conditions) that can be sustained such that the losses (energy dissipation from the superconductor) do not exceed the target or specific ac loss levels identified for the device.

The matrix metal is preferably silver-based. As is discussed in further detail herein, the compositions of the inner and outer matrices may be identical or they may vary. In at least some embodiments, the matrix 15, made up of an inner matrix 16 and an outer matrix 18, may be pure silver. In at least some embodiments, at least the outer matrix 18 is an oxide dispersed silver (ODS) alloy of a composition similar to that described below for the bridging material. In addition to increasing electrical resistance, ODS alloy matrices may improve conductor strength, robustness and I_{c} stress/strain tolerance. For example, ODS silver yields at >30 ksi while pure silver yields at 5-10 ksi after final heat treatment. The dispersed oxide (ksi=10 lb/in²) content of the ODS silver alloy may be adjusted downward to provide a ductile composite, which helps to maintain composite flexibility while imparting other desirable properties to the article. The inner matrix 16 may be pure silver or it also may be an ODS silver. A pure silver inner matrix promotes higher conductivity adjacent to the superconducting filament core, which may serve as an electrical shunt in the event of filament breakage. It also reduces oxide superconductor poisoning by reducing contact of the oxide filament with other (potentially reactive) metals.

The high resistance layer contains insulating materials or their predecessors, which are typically insulating metal oxides. Predecessor materials include metals or metal alloys which can be converted into the insulating metal oxide at the appropriate stage in the manufacture of the article. The appropriate material for use in the high resistivity region is determined by the desired resistivity of the resultant oxide layer and also the ductility and chemical compatibility of the metallic precursors used in the manufacture of the article. The ductility and chemistry of the metallic precursors desirably is compatible with the ductile metal matrix (typically silver), the oxide superconductor and the composite manufacturing process. It also must be able to produce thin, uniform, low perforation oxide layers upon oxidation. Suitable predecessor metals, include but are not limited to, nickel, lead, ytterbium, aluminum, copper and calcium. Suitable metal oxides, include but are not limited to, oxides of nickel, lead, ytterbium, aluminum, copper and calcium metals.

Nickel and lead are among the elements that neither react with nor dissolve in silver. This attribute helps to preserve thin, dense metal layers during anneals and other warm processing steps. High purity, low carbon nickel exhibits ductility comparable to silver, at slightly higher flow stresses, and it is well known to form dense, thin NiO layers. Lead also is capable of forming stable, oxide superconductor-compatible oxides in combination with aluminum or calcium. Ytterbium can form intermetallic compounds with silver, but possesses desirable attributes such as ductility and extreme oxide stability. Both nickel and ytterbium have been successfully deformation-processed with silver. Upon oxidation, dense metal oxide films on the order of one micron have been formed.

Complex metal oxides may also be obtained by using a predecessor metal alloy. Of particular interest are oxides in the Ba/Ca—Cu—O system such as Ba₂Cu₃O₅ or CaCuO₂, and oxides in the Ba—Zr—O, Ca—Zr—O or Sr—Zr—O systems, which form zirconates. These may be doped with additional elements such as yttrium (Y) to stabilize the desired phase, e.g., cubic barium zirconate (YBZ). Other complex oxides of interest include titanates and vanadates because of their stability with respect to oxide superconductors.

Oxygen transport to the filament interior may be hindered by the complete enclosure of the oxide filament by the high resistance layer. Bridges are included in the high resistivity layer to promote oxygen transport within the composite. The number of bridges in the high resistivity region 14 desirably is selected to balance the need for oxygen diffusion into the composite and the need to maximize interfilament resistivity. Breaks in the high resistivity region provide areas through which interfilament current loops may form, giving rise to coupling losses, and are thereby kept to a minimum. Countering this need is the desire to permit current sharing between oxide superconducting filaments in the event of local thermal heating or a short circuit, and the need to permit oxygen transport across the high resistivity region and into the oxide filament for oxide superconductor phase formation and stabilization. Neither of these goals is possible when there is complete physical and electrical isolation between filaments.

In at least some embodiments of the invention, low resistivity, high oxygen permutivity bridges are incorporated into the high resistivity region. In at least some embodiments, the bridges occupy greater than 0.001% vol/vol of the high resistivity layer for minimally adequate current sharing, when current sharing is considered desirable. In those instances where local thermal heating and/or short circuit is considered a possibility, the bridges may occupy greater than 1.0% vol/vol of the high resistivity layer. In at least some embodiments of the invention, the bridges occupy no more than 20%, or no more than 15% vol/vol. In at least some embodiments of the invention, the bridges occupy less then 10% vol/vol, or less then 5% vol/vol, or about 3%, 2% or 1% vol/vol of the high resistivity region. This level of perforation has been found to provide the desired balance between the competing needs to minimize coupling losses and to permit current sharing and oxygen transport.

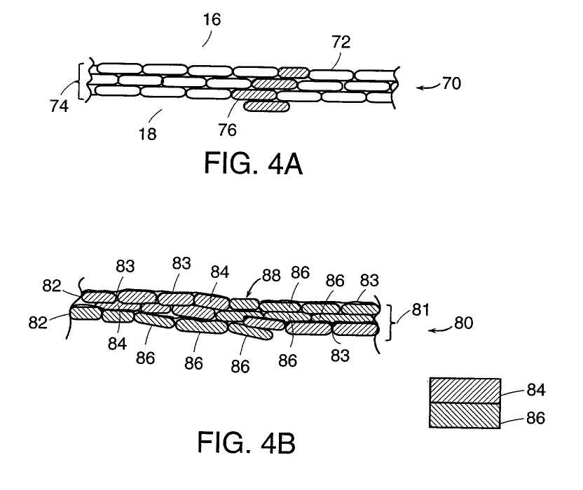

The high resistance layer is thin relative to the thickness of the metal matrix. Typical aggregate thickness of the high resistance layer around a filament may be in the range of 0.1 μm to 2.0 μm, with considerable local variation thereof, without impairment of the effectiveness of the high resistance layer. As shown in detail in FIGS. 4A and 4B, the high resistance region is permeated with bridging material 76 or 86 having a resistivity intermediate to those of the metal matrix and high resistivity material, and a higher oxygen diffusivity than the high resistivity material. In at least some embodiments as is shown in FIG. 4A, the high resistivity region 70 includes grains 72 of high resistance material densely arranged in a layer 74 with bridges 76 spanning the high resistivity material. In at least some other embodiments, as is shown in FIG. 4B, the high resistivity region 80 is made up of multiple thin lamellae 82 of metal oxide (or other high resistivity material) with matrix metal 84 or the bridging intermediate resistivity material 86 disposed therebetween. This is demonstrated in FIG. 4B, in which the grain boundaries of metal grains 84 or grains of the bridging material 86 (note: hatching direction distinguishes between metal and bridging material) are coated with the high resistivity material 83 so as to form a lamellar structure 82 having many fine layers of the high resistivity material. The high resistivity layer may have the appearance of a honeycomb, which coats or decorates the grain boundaries, or prior grain boundaries, between matrix metal grains. Prior grain boundaries include regions which contain metal grains at the time of high resistivity layer formation, but which have been transformed in subsequent processes and no longer contain metal grains. The regions may now be occupied by grains of bridging material 86. The lamella exhibit occasional gaps 88 in the strata, which are occupied by bridges 86 of the invention. Each of the oxide lamella may be very thin, for example, on the order of 0.05-0.5 μm. Bridging material may extend beyond the high resistivity region into the matrix metal.

In at least some embodiments, bridges in the high resistivity region are filled or spanned with a material that provides some resistance to current flow to act as an impediment to electrical coupling. Thus, the material occupying the bridges of the high resistivity region has a resistivity of greater than 0.4 μΩ-cm (the resistivity of pure silver). The higher resistance experienced at the perforation due to the presence of the higher resistivity material mitigates the potential harm to ac loss caused by defects in the layer. In at least some embodiments, the material occupying the perforation has a bulk resistivity that is greater than 5 times, preferably greater than 10 times, and more preferably up to 100 times the resistivity of pure silver.

The bridge material also demonstrates a higher level of oxygen diffusivity than the relatively oxygen-impermeable high resistivity material. In at least some embodiments, the bridge material is a silver-based dispersed oxide material, i.e., ODS silver, and preferably comprises the metal oxide of the high resistivity layer (for increased compatibility with the resistive material phase). In at least some embodiments, the oxides of the ODS silver may include oxides of Al, Mg, Ti, Si, Co, Ni, Zr, Hf and/or rare earth elements or, in at least some embodiments, is an aluminum or magnesium oxide or mixtures thereof. The oxides may be present in an amount up to 5.0 % vol/vol or, in at least some embodiments, in an amount in the range of 1.0 to 5.0 % vol/vol. In at least some embodiments, the bridges are adherent to, preferably at the atomic level, i.e., metallurgically bonded to, the high resistivity material. In addition to volume percent of the dispersed oxide, the particle size of the dispersed oxide particles may be considered. In at least some embodiments, the particle size is at most 0.1 micrometers in size to effectively increase silver's resistance to the required levels in the bridges.

By selection of a silver-based bridging material having an elevated resistivity to that of silver sheath, the composite is able to balance the need for sufficient bridging to permit oxygen transport through the sheath, while maintaining an adequate level of resistance to prevent coupling losses. The bridges provide a layer morphology, which attains the desired filament-to-filament resistance, while allowing current sharing with reduced ac losses and oxygen transport to take place.

An additional and unforeseen advantage of including high oxygen permutivity bridges in the high resistivity layer is that the multifilamentary strand is able to tolerate a higher level of perforations without deleterious effect on the filament-to-filament resistance and related ac losses. This higher tolerance of layer defects permits the manufacture of the article using processes capable of imparting high J_{c}, while retaining desirably low ac losses. For example the article can be deformed at least to strains up to about 10%.

High filament-to-filament resistance is directly related to the reduction of ac coupling losses. If the resistivity of the layer or region separating adjacent oxide superconducting filaments is sufficiently high, i.e., its resistance exceeds the resistance of the area bounded by the region, then coupling between filaments will be very low. The coupling pathway between filaments is perpendicular to the filament surface and known as perpendicular coupling. Interfilament resistance, R*, may be determined from a standard four-point probe transport resistance measurement, Rₘₑₐₛ, at a temperature below the critical transition temperature, and using the relationship,

R* =Rₘₑₐₛ·L,

where L is the length of the sample measured. Measured transport resistance is multiplied by the sample length to normalize resistance among samples of different lengths (resistance is lowered with increasing filament length due to the larger filament area available to pass current). This measurement provides the interfilament resistance for filaments that are not unduly large, and is accurate for samples having, for example, interfilament spacings, i.e., the span between adjacent oxide superconducting filaments, of about 10-100 μm and filament widths of about 100-1000 μm.

For filaments significantly larger than those falling within these ranges, the resistance may be determined using the relationship,

R**=R*·C,

where C is the perimeter length of the high resistance layer. In at least some embodiments for reduced ac losses, the resistance at operating conditions (T<T_{c}, in field) R* exceeds 10⁻⁶ ohm-cm, or even 10⁻⁵ ohm-cm. However, for current sharing, the maximum resistance may be less than about 1 ohm-cm, defining a useful, intrastrand filament-filament resistance.

Another example of a bridging region used to promote oxygen diffusivity and current sharing is shown in FIG. 5, in which the geometry of the high resistance layer has been modified to promote oxygen transport into the composite interior. The multifilament composite is made up of a plurality of monofilaments 20. The monofilament 20 includes an oxide superconductor filament (or precursor thereto) 22, which is surrounded by a high resistance layer 24. The superconducting filament may be a relatively phase pure oxide superconductor, or it may contain elongated bands of materials such as silver that can enhance texture and current density in the superconducting oxide. The high resistance layer forms an open spiral enclosure around the central oxide superconducting filament having one or more turns about the center. The spirally-formed or “jelly roll” geometry of the high resistance layer includes a bridging material (not shown). An outer metal matrix region 28 and an inner metal matrix region 29 surround the jelly roll-bridging material composite and can be of the same or different composition as the bridging material. In at least some embodiments, the matrix metal is silver or its ODS alloys as described herein above. Thus, a conduit for oxygen transport is retained in the composite, while simultaneously introducing an effective high resistance layer.

The bridging material used in the jelly roll configuration desirably has a modified composition, such as ODS silver, having a higher resistivity as is described herein above; however, due to the multiple layers of resistive material, the bridging material may be a conductive metal, such as pure silver. That is, the resistivity of the bridges in a jelly roll configuration 20 may be lower than in the enclosed configuration 10. The interfilament resistance can be varied greatly by varying the geometry (number of turns, i.e., complete circling of the core) and the silver composition of the spiral insulating oxide-silver layers. In at least some embodiments, the number of turns is the minimum needed to raise the bulk resistivity of the matrix so as to prevent interfilament coupling. An undue number of turns is not desired because it increases the tortuosity of the path through which oxygen must diffuse during oxidation. The number of turns is in the range of one to four or, in at least some embodiments, about two.

The theoretical interfilament resistance can be calculated and modified based upon the following relationship:

R≈8ρn(wᵣ+tᵣ)/tⱼPₜₚ,

where ρ is the matrix resistivity, Pₜₚ is the twist pitch length, n is the number of jelly roll turns, wᵣ and tᵣ are the jellyroll enclosed region's width and thickness, respectively, and tⱼ is the metal thickness in the jelly roll. Thus, increasing the number of jelly roll turns or increasing silver matrix resistivity will increase R. For typical values of 0.015 cm and 0.005 cm for wᵣ and tᵣ, respectively, and silver matrix resistivities in the range of 3×10⁻⁵ to 10⁻⁷ Ω-cm resistance is in the range of 4.8×10⁻² to 10⁻⁵ Ω (for a twist pitch of two, a single jelly roll layer and matrix thickness of about 10⁻⁴ to 10⁻³ cm). In at least some embodiments, a higher resistivity ODS silver alloy, i.e., a higher oxide content, is used in the jelly roll than is used in the surrounding metal matrix. In at least some embodiment, ODS silver with up to 100 times the resistivity of pure silver (30 μΩ-cm v. 0.3 μΩ-cm) separates the dense oxide layers from each other in the jelly roll. The open geometry of the jelly roll high resistance layer provides a conduit for oxygen diffusion through silver pathways in the high resistance layer.

The composite filaments may be helically twisted about the composite article axis to further reduce filament-filament coupling losses. In at least some embodiments, the direction of twisting may be reversed after circling a prescribed number of degrees, e.g., the twist pitch may oscillate. The twist pitch (the axial distance traversed by a complete twist of the filament) may be selected to attain the desired loss characteristics, however, it is typically in the range of about 0.2 cm to 5.0 cm, and more preferably in the range of about 0.2-3 cm, and preferably about 0.2-1.5 cm. A twist pitch is used in a filament decoupling approach, i.e., each filament has a resistive layer surrounding it. If just using strand decoupling with rather narrow strands, then the cable lay-up pitch becomes the “twist” pitch of the cabled conductor. In at least some embodiments, the strand is drawn and then twisted. In at least some embodiments, the strand may be twisted and then drawn.

In at least some embodiments, the oxide superconducting filaments remain physically separated from their neighboring filaments after processing. In at least some embodiments, the oxide filaments substantially surrounded by the high resistivity region do not merge with their neighboring filaments more frequently than once every twist pitch, and preferably once every two, four or six twist pitches.

The multifilamentary composite further may include an outer high resistivity layer that encircles the entire composite, shown as layer 34 in FIG. 1. This layer may be used when the multifilamentary composite is to be used as a strand for further incorporation into a cable and serves the purpose of electrically isolating the strand from adjacent strands in the cable. The high resistivity layer 34 may include any of the metal oxides described herein for use in the high resistivity regions 14 or 24 and may have a bulk resistivity at least ten times, and preferably at least 100 times that of silver. The multifilamentary composite may have a further outer layer 36, which is capable of forming an adherent bond with adjacent strands in a cable configuration and serves to fix and stabilize the strands within a cable. The layer 36 may include silver or its alloys, or another noble metal, or a ceramic or glass that softens and permits sintering between the strands. Layer thickness for the other adherent layer is in the range of about 3-30 μm.

The invention may be practiced with any desired oxide superconductor or its precursors. By “desired oxide superconductor” is meant the oxide superconductor intended for eventual use in the finished article. Typically, the desired oxide superconductor is selected for its superior electrical properties, such as high critical temperature or critical current density. By “precursor” is meant any material that can be converted to an oxide superconductor upon application of a suitable heat treatment. Precursors may include any combination of elements, metal salts, oxides, suboxides, oxide superconductors which are intermediate to the desired oxide superconductor, or other compounds which, when reacted in the presence of oxygen in the stability field of a desired oxide superconductor, produces that superconductor. For example, there may be included elements, salts, or oxides of copper, yttrium or other rare earths, and barium for the rare earth family of oxide superconductors (RBCO); elements or oxides of copper, bismuth, strontium, and calcium, and optionally lead, for the BSCCO family of oxide superconductors; elements, salts, or oxides of copper, thallium, calcium and barium or strontium, and optionally bismuth, and lead, for the thallium (TBSCCO) family of oxide superconductors; elements, salts, or oxides of copper, mercury, calcium, barium or strontium, and optionally, bismuth or lead, for the mercury (HBSCCO) family of oxide superconductors. The bismuth and rare earth families of oxide superconductors are most preferred for operation of the invention. By “oxide superconductor intermediate to the desired oxide superconductor” is meant any oxide superconductor which is capable of being converted to the desired oxide superconductor. The intermediate oxide may alternatively be referred to as an oxide precursor to an oxide superconductor. The formation of an intermediate may be desired in order to take advantage of desirable processing properties, for example, a micaceous structure, which may not be equally possessed by the desired superconducting oxide. Precursors are included in amounts sufficient to form an oxide superconductor. In some embodiments, the precursor powders may be provided in substantially stoichiometric proportion. In others, there may be a stoichiometric excess or deficiency of any precursor to accommodate the processing conditions used to form the desired superconducting composite. For this purpose, excess or deficiency of a particular precursor is defined by comparison to the ideal cation stoichiometry of the desired oxide superconductor. The addition of doping materials, including but not limited to the optional materials identified above, variations in proportions and such other variations in the precursors of the desired superconducting oxides as are well known in the art, are also within the scope and spirit of the invention.

The three-layer, high T_{c} phase of a member of the BSCCO family of superconductors, such as Bi₂Sr₂Ca₂Cu₃Oₓ (BSCCO 2223) or (Bi, Pb)₂Sr₂Ca₂Cu₃Oₓ ((Bi,Pb)SCCO 2223), is one of the desired superconducting oxides most preferred for the operation of the present invention. Composites including BSCCO 2223 (Bi,Pb)SCCO 2223 have demonstrated the potential for superior mechanical and electrical performance at long lengths when adequately textured. The current-carrying capacity of a superconducting oxide composite depends significantly on the degree of crystallographic alignment and intergrain bonding of the oxide grains, together known as “texturing”, induced during the composite manufacturing operation. For example, known techniques for texturing the two-layer and three-layer phases the bismuth—strontium—calcium—copper-oxide family of superconductors (BSCCO 2212 and BSCCO 2223, respectively) are described in Tenbrink, Wilhelm, Heine and Krauth, Development of Technical High-Tc Superconductivity Conference, Chicago (August 23-28, 1992), and Motowidlo, Galinski, Hoehn, Jr. and Haldar, “Mechanical and Electrical Properties of BSCCO Multifilament Tape Conductors,” paper presented at Materials Research Society Meeting, Apr. 12-15, 1993.

The superconducting filament may be a relatively phase pure oxide superconductor, or it may contain elongated bands of materials such as silver that can enhance texture and current density in the superconducting oxide. It has been demonstrated that oxide superconductor grains will align along a silver interface. By providing multiple conductive pathways within the oxide superconductor matrix for alignment, texture can be enhanced.

Low ac loss cables. The present invention also provides low ac loss cables. The cable includes a plurality of strands each having an outer resistive layer that reduces interstrand current coupling. Each strand is adherently bonded to adjacent strands and to an optional central former. The former is not required to obtain a low loss cable, however, it aids in the cabling operation and may provide an additional high resistivity region to further discourage electrical coupling.

The superconductor cable of the invention dissipates power of less than 0.5 W/cm³ or, in at least some embodiments, less than 0.05 W/cm³ at T<T_{c}, Jₒₚ>1000 A/cm² (operating DC or root mean square (RMS) AC current density) in an average magnetic field time rate of change of greater than 0.1 T/s or, in at least some embodiments, greater than or equal to 1 T/s or, in at least some embodiments, greater than or equal to 5 T/s, and at maximum magnetic fields of up to 0.0025 T or, in at least some embodiments, up to 0.1 T, or, in at least some embodiments, up to 10 T. Part of this field may be a static dc-type field with an ac ripple or ramp.

In at least some embodiments, the composite cable conductor possesses a sufficiently high interfilament resistance, short twist pitch length, and low incidence of filament merger to reduce ac losses in the poorest conductor orientation, e.g., perpendicular to the plane of the conductor, to less than 50 mW/Am or, in at least some embodiments, less than 20 mW/Am or, in at least some embodiments, less than 2 mW/Am, in a conductor with an I_{C} (self field at 77K) of greater than or equal to 20A or, in at least some embodiments, greater than or equal to 50 A or, in at least some embodiments, greater than or equal to 100 A (although loss would be determined over a temperature range of about 20-80K), and at a field ramp rate of greater than or equal to 0.1 T/s, or greater than or equal to 1 T/s, or greater than or equal to 5 T/s. Alternatively, the measurement is taken in RMS fields of greater than or equal to 0.02 T, or greater than or equal to 0.05T, or greater than or equal to 0.1 T for frequency ranges of 1 Hz to 1000 Hz.

In addition to low ac loss, cables of the invention are capable of high dc current transport. The direct current I_{c} at T_{c}>64K, 1 μV/cm, is greater than or equal to 30 A or, in at least some embodiments, greater than or equal to 60 A. Current as high as 100 A at 77K have been measured. The cables of the invention also demonstrate a Jₑ of at least 2 kA/cm² at 77K, self field.

In at least some embodiments of the invention, the cables are planetary cables, in which the orientation of the individual strands is constant throughout the cable. Planetary cabling involves hard edge-bending of the individual strands during assembly, which places considerable stress at the bend-points. In at least some embodiments of the invention, the cable includes a central core that has curved or scalloped edges along its long, thin dimension. The curved edges minimize the angle at which the strands need to bend in a planetary winding.

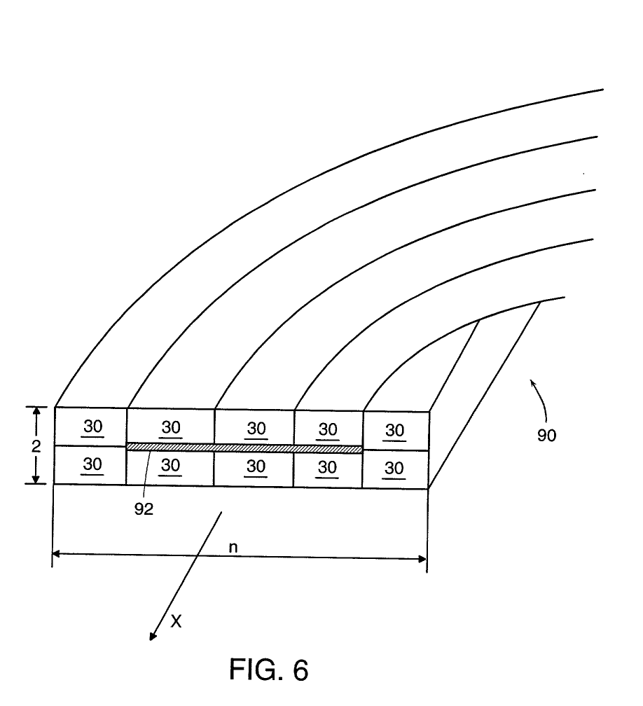

FIG. 6 shows a typical 2×n planetary cable 90 of the invention, in which multifilament strands 30 are transposed about an optional former 92. Reference to a 2×n cable does not mean that an even number of strands is required. The actual arrangement of strands is a function of the cabling technique and the deformation/shaping operation used. An odd number of strands is possible, for example, in the case where only a single strand occupies an edge position in the cable. The strands are arranged about the longitudinal axis of the cable shown in FIG. 6 as the x-axis. In at least some embodiments, the strands are metallurgically bonded to one another through adjacent contacting silver surfaces of the strands 30. The cable may be made up of multiple layers of planetary wrapped strands to increase strand count, where desired. The strand lay-up (distance along the cable axis traversed by a strand in making a full circle about the x axis) is about 2 to 10 times the twist pitch of the individual strand filaments, or in at least some embodiments is less than 100 cm, or less than 50 cm, or, in at least some embodiments, is less than 20 cm or, in at least some embodiments, is in the range of 3-15 cm.

The former may be a conductive or resistive core, which serves as a support for strands during cabling and as a guide for strands during cabling. Resistive core formers may serve the additional purpose of further electrically decoupling the strands within the cable. In at least some embodiments, the former is made up of a ductile metallic core coated with a high resistivity material, such as ODS silver, or a ceramic material. In at least some embodiments, the metal may be any one of many known high temperature, oxygen-resistant alloys that rely on thin, oxygen-impermeable layers of oxide to provide oxidation resistance. In at least some embodiments, the former may be comprised entirely of a high resistivity material, e.g., a ceramic. The ceramic may demonstrate stability towards the oxide superconductor, and may be those oxides identified for use as the high resistivity material in the individual strands. Exemplary materials include metal oxides such as nickel, lead, ytterbium, aluminum and calcium. Complex metal oxides may also be used. Of particular interest are oxides in the Ba/Ca—Cu—O system such as Ba₂Cu₃O₅ or CaCuO₂, and oxides in the Ba—Zr—O, Ca—Zr—O or Sr—Zr—O systems, which form zirconates. These may be doped with additional elements such as Y to stabilize the desired phase, e.g., cubic barium zirconate (YBZ). Other complex oxides of interest include titanates and vanadates because of their stability with respect to oxide superconductors. Preferred ceramics include non-magnetic oxides such as oxides in the Cu—Ni—Al—O family and zirconates. A novel former having edge features may be employed, which has been found to greatly improve the ease of cabling and quality of the resultant cable. Edge features of the former aid in the lay-up and edge-bending of the strands.

In at least some embodiments, the center former is metal-cored and is made from primary alloys, typically containing Al, Si or Cr, such as those previously described. The primary alloy former is oxidized upon exposure of the alloy to oxidizing conditions to provide barrier-oxide layers, i.e., Al₂O₃, SiO₂, and Cr₂O₃, at the former surface. These oxides do not react with the external surface of the strand except for bonding when heated to complete formation of the superconducting phase(s). Suitable center former alloys include, but are not limited to, Inconel, Haynes, Hastalloys, In—Al alloys, Cu—Al—Ni alloys and stainless steel.

Additional material may be applied to the outermost surface of the cable for enhanced robustness. Preferred materials include soldered stainless steel, or a sintered alumina, chromia, or silica scale-forming alloy of the Haynes, Hastelloy or Inconel variety, Ni—Al alloys, Cu—Al—Ni alloys and stainless steel.

The cable may include up to 500 strands and preferably includes greater than 2 and less than 200, or less than 100, or about 10-30, and more preferably about 6-18, and still more preferably about 4-12 strands per cable. In those instances where high strand counts are desired, multiple layers of planetary lay-up strands may be used in a single cable architecture. Exemplary cables may have an overall dimension of about 0.04-0.05 cm in thickness by about 0.3-0.5 cm in width, and may have an aspect ratio in the range of about 4-10:1.

Manufacture of strands and cables. In yet another aspect, the invention provides a method of manufacturing a multifilamentary superconducting composite article having improved ac loss properties. The process enables the incorporation of a brittle oxide layer into the composite without significant mechanical failure or breakage and while retaining high interfilament resistivity.

For multifilamentary articles, the oxide-powder-in-tube (OPIT) method generally includes the three stages of (a) forming a powder of superconducting precursor materials (precursor powder formation stage), (b) filling a noble metal billet with the precursor powder, longitudinally deforming and annealing it, forming a bundle of billets or of previously formed bundles, and longitudinally deforming and annealing the bundle to provide a composite of reduced cross-section including one or more filaments of superconductor precursor material surrounded by a noble metal matrix (composite forming stage); and (c) subjecting the composite to successive asymmetric deformation and annealing cycles to texture the composite, and further thermally processing the composite to form and sinter a core material having the desired superconducting properties (thermomechanical processing stage). However, if this conventional OPIT process is used for the preparation of multifilamentary composites having a metal oxide as the high resistivity material, high interfilament resistance and low ac loss is not realized. The oxide particles do not deform plastically and the drawing and texturing deformation steps of the OPIT destroy the continuity of the oxide layer, rendering it unable to decouple current loops between adjacent filaments. Significant modifications to the process are required in order to obtain the low loss multifilamentary composite of the invention.

In at least some embodiments of the invention, the final oxide superconductor is BSCCO 2223 or (Bi,Pb)SCCO 2223 and the oxide precursor is BSCCO 2212 or (Bi,Pb)SCCO 2212 and additional secondary phases, e.g., BSCCO 0011, necessary to provide the proper overall stoichiometry for BSCCO 2223. BSCCO 2212 plus secondary phases is a preferred precursor oxide because the grains of BSCCO 2212 are readily densified or textured using conventional processes. For the purposes of illustration, the method is described for the BSCCO oxide superconducting system; however, it is contemplated that the method may be adapted for use in other oxide superconducting systems.

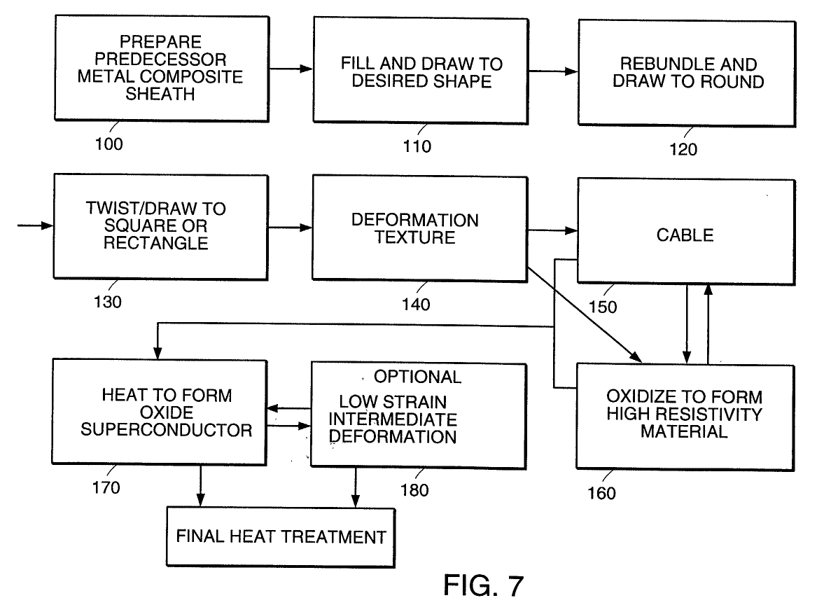

FIG. 7 is a processing profile for a method of the invention used to obtain low ac loss strands and/or cables having high interfilament resistance.

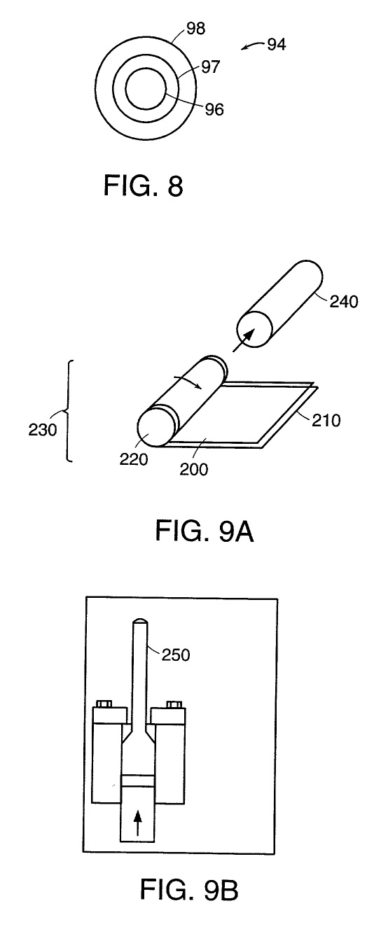

In the first step 100, a sandwich rod 94 is prepared having a ductile predecessor metal to the high resistivity material embedded between two regions of the matrix metal (see FIG. 8.) The sandwich construction is prepared such that all three components are metallurgically bonded to form an integral unit. In at least some embodiments, a silver core (or its alloys) 96 in the form of a tube or rod is cleaned by chemical and/or mechanical means and surface roughened in preparation for wrapping a ductile predecessor metal sheet or foil 97 around the core. A silver sheath 98 is similarly prepared and the silver core/foil combination is packed into the outer silver sheath.

If a jelly roll configuration is desired for the high resistivity layer, the ductile predecessor metal foil 200 may be combined with a silver or silver alloy foil 210 (of higher resistivity) and the combination may be spirally wrapped around a silver or silver alloy core 220, as is shown in FIG. 9A. The core/jelly roll combination 230 is then inserted into a silver or silver alloy billet 240 under clean conditions. The ductile predecessor metal also may be deposited as a thin layer on the silver core using conventional physical deposition methods, such as RF sputtering or laser ablation and the like, or electroplating, which may then be inserted into the silver billet 240 to obtain a silver core-foil-silver billet assembly 250. The typical predecessor metal layer is very thin having a thickness on the order of 1/80 to 1/800 of the total thickness of the sandwich composite sheath enclosed core. In general, the foil thickness is selected so that the final average foil thickness immediately prior to oxidation is less than 4 μm, and preferably less than 1.0 μm.

The silver core-foil-silver billet combination 94 or 250 is then sealed, evacuated and consolidated into a round rod or tube shape using extrusion or isostatic pressing under ambient or elevated temperatures, as is shown in FIG. 9B. The process is carried out under conditions of sufficiently low temperature and oxygen pressure so that no conversion of the predecessor metal into a metal oxide occurs. Proper selection of the predecessor metal assures that it co-deforms well with the silver or silver alloy materials of the sheath. For aluminum, by way of example, temperatures of 100-200° C., e.g., about 150° C., are sufficient to form the billet while avoiding formation of intermetallic compounds and oxidation.

The silver core (inner matrix), silver sheath (outer matrix) and/or the silver foil (for the jelly roll configuration) may be pure silver (or other noble metal) or a silver reactive metal alloy that can form an ODS silver alloy under the appropriate reaction conditions. In at least some embodiments, both the outer matrix and the silver foil of the jelly roll configuration or the inner and outer matrix of a substantially surrounding configuration may include ODS silver. In at least some embodiments, the matrix alloy consists of silver having aluminum or magnesium in the 0.1-5 wt % range. In at least some embodiments, the resistivity of the ODS silver in the jelly roll is higher than that of the surrounding matrix metal. The resistive may be in the range of greater than or equal to about five times, or greater than or equal to about 10 times, or greater than or equal to about 20 times that of the silver matrix, e.g., about 1-100 μΩ-cm.

In at least some embodiments the predecessor layer may be prepared from metals that exhibit stress deformation profiles similar to that of silver. Exemplary metals include Ni, Yb, Cu, Pb, Al, and Ca, and mixtures thereof. Other elements may be included which enhance properties such as oxygen diffusivity, formability, and/or chemical compatibility. In at least some embodiments, the predecessor metal comprises aluminum, and preferably comprises high purity (99.9%) aluminum. The aluminum may include alloying additions of up to 5 wt % of elements each as K, Na, Li, Sr, Mg, Cu, Ca, Si, and Mn. In at least some embodiments, the predecessor may be nickel or its alloys, and preferably may be low carbon nickel, such as Ni270 or Ni290. In at least some embodiments, the predecessor metal may be copper and its alloys, such as, by way of example, low oxygen content copper. The predecessor layer may include alloys of two or more elements that, after oxidation, can be reacted to form complex oxides. Such alloys may be prepared by conventional processes such as mechanical alloying or molten metal casting.

In at least some embodiment, the metal precursor to a complex oxide may be a composite of ductile metal foils of the appropriate thickness to provide constituent element ratios needed in a final high resistivity oxide. For example, combinations of sheets of Al and Pb, Al and Ni, Al and Cu, and Cu and Ni, and mixtures thereof, are contemplated. These foils are then wrapped about a center core, packed into the sheath and formed into a metallurgically bonded composite as described above. In at least some embodiments, the metal that is more reactive to silver is sandwiched between foils of less reactive metal. The foils may be converted into alloys by diffusion, or they may be carried through the process as a composite foil. Upon oxidation, the elements may mix, or they may form simple oxides with the formation of the desired complex oxide in a subsequent reaction step that may or may not be part of the oxide superconductor forming and sintering steps.

In at least some embodiment, a precursor to a complex oxide high resistivity region may be a composite alloy in which one or more constituents are metal and some other constituents are finely dispersed metal oxides or other ceramic, e.g., metal nitrides. An example of this is the mechanical alloying of micron-sized ZrO₂ into barium and/or strontium metal in the appropriate ratio to form barium (or strontium) zirconate. In a related approach, one or more constituent metal elements of a complex oxide is alloyed or mixed into the inner or outer matrix, while the metallic predecessor layer includes the remaining constituent elements of the oxide. Upon oxidation, the predecessor metal is converted into an oxide and subsequent reaction allows some of the metal element constituents in the sheath to diffuse to the oxidize layer and form the desired complex oxide.

In at least some embodiments as discussed above, the predecessor metal-containing composite exhibits ductility comparable to silver so that the sandwich composites may be consolidated and subsequently co-extruded without break-down of the metal foil layer. Suitable ductility is determined by measuring the ductility of foils used in the composite, relying on published data, or by observing foil behavior under use conditions.

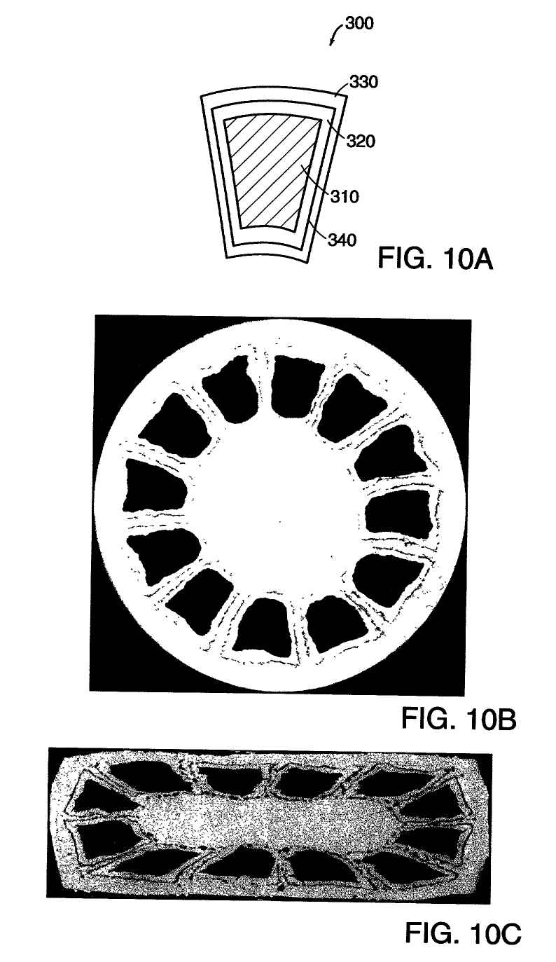

In step 110 of the process, the sandwich composite is then drilled to give a hollow bore (where necessary) into which precursor powders to the desired oxide superconductor can be introduced. The hollow bore sheaths are then filled with oxide precursor powders, sealed and drawn into monofilament rods of suitable size. The rods may be drawn to a round or hexagonal cross-section. In at least some embodiments of the present invention, the monofilaments have a quasi-trapezoid cross-section having curved inner and outer surfaces as is shown in FIG. 10A. The trapezoid rod 300 includes a precursor powder core 310 surrounded by inner and outer silver matrices 320, 330 in which a predecessor metal 340 is embedded. Such a cross-section provides high space filling efficiency in subsequent bundling operations and significantly reduces the incidence of filament merging in subsequent size reducing and deformation texturing operations because the shape most nearly approximates that of the filament in the final round strand. Well known processes may be used to elongate the rod, such as extrusion, drawing, strip, bar or Turk's head rolling or swaging.

The consolidation steps described above are carried out under conditions and in a manner that result in adherent, well-bonded interfaces, without undesirable reaction of the component materials, e.g., formation of intermetallic compounds. Thus, in at least some embodiments, the consolidation is carried out under “warm” deformation using high consolidation pressures. Exemplary conditions include deformation at room temperature (relying on frictional heating as the only heat source) or cold welding under compressive stresses that are at least 1.5, and preferably about 2, times the flow stresses of the sheath ductile foil materials.

The advantages to the above process is that the initial fully metallic sandwich composite may be homogeneously co-deformed to form fine filament composite wire with each filament surrounded by a very thin and uniform thickness, i.e., micron or submicron, non-perforated precursor to the high resistivity layer. Upon oxidation, this forms a dense, well-connected low-perforation oxide layer that effectively reduces ac losses.

In at least some embodiments, a number of similarly deformed rods are then repacked into a metallic tube around a central core and deformed again to obtain a multifilament wire of reduced cross-section, as is shown as step 120. The core may be pure silver, a reactive metal silver alloy, a metal-coated insulating ceramic or an additional round monofilament superconductor oxide rod. Typical wire diameters are in the range of 0.3-2 mm. Consolidation factors such as those described above are also taken into account.

In at least some embodiments, the multifilament wire is then twisted in step 130 to a desired twist pitch (ca. 0.2-5 cm) and is further processed into a square or rectangular shape of low aspect ratio. The aspect ratio is selected to aid in subsequent texturing operations and is on the order of 2-3:1.

In step 140 in at least some embodiments, the multifilament wire is then deformation textured. Rolling or pressing may be used to deform the wire and orient the oxide precursor grains. Alignment of the superconducting oxide grains has been observed in long, thin filaments constrained within a metal matrix. The wire is reduced to final dimension in which at least one dimension of each filament has obtained the desired. In at least some embodiments, the oxide filament is of a dimension on the order of the longest dimension of the oxide superconductor grain. Filaments having thickness on this order, e.g., 35 microns, or 25 microns, or 10 microns or less than 5 microns, often demonstrate preferential orientation due to constrained growth of the oxide grains. See, International Application No. WO 92/18989, entitled “A Method of Producing Textured Superconducting Oxide Bodies by the Oxidation/Annealing of Thin Metallic Precursors” filed Oct. 29, 1992, the contents of which are incorporated by reference.

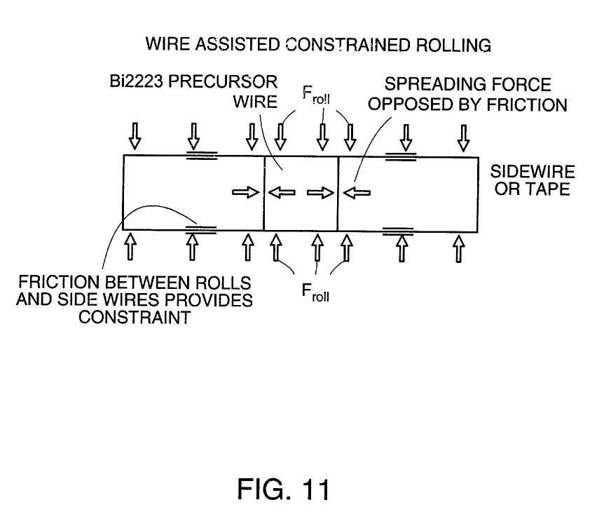

In at least some embodiments, the aspect ratio of the resultant textured strand is minimized in order to reduce hysteresis losses. To this end, the wire may be textured in a constrained rolling operation in which stationary side wires or tapes prevent lateral spreading of the wire during rolling. The process is schematically illustrated in FIG. 11, and is described in further detail in U.S. Pat. No. 5,885,938, entitled “Low-Aspect Ratio Superconductor Wire”, which is hereby incorporated by reference. The wire may be rolled in a single pass or in multiple passes to strains in the range of 30% to 85% cross-sectional area reduction. In the instance where multiple rolling operations are used, no intermediate heat treatments are performed. In at least some other embodiments, small diameter rolls are used which minimize the extent of lateral spread of the strand.

In at least some embodiments, a fully textured precursor oxide phase is obtained using a single high reduction rolling operation, which reduces the composite thickness in the range of 30-85% in a single rolling pass. A high reduction rolling operation has been shown to be highly effective in producing a high density, highly textured oxide phase. The single deformation step introduces a high level of deformation strain, e.g., 30-85%, and preferably 55-80% strain, by reducing the article thickness in a single step. The high reduction process distributes the deformation energy throughout the article. Thus, the entire filament experiences similar densifying and texturing forces, leading to greater filament uniformity and degree of texture. Such processing additionally has been found to eliminate undesirable non-uniformities along the length of the oxide filaments, thereby reducing the incidence of filament merger while providing consistently better electrical transport properties in the final article. Such processing may be used with any method used to obtain the final oxide superconducting phase. As a further advantage, the process provides a densified and textured precursor oxide in a single deformation step, as compared to more traditional methods of precursor processing which involve multiple anneal and texturing deformation steps. This process may be readily integrated into the manufacture of a low ac loss strand because it does not require intermediate heat treatments which would convert the predecessor metal foil into a brittle metal oxide and it provides an oxide microstructure which yields excellent J_{c} performance. Further information on a single step deformation process may be found in U.S. Pat. No. 6,247,224, entitled “Simplified Deformation-Sintering Process for Oxide Superconducting Articles,” which is hereby incorporated by reference.

BSCCO 2212 may be prepared having either an orthorhombic or tetragonal solid state lattice symmetry. In prior art processes, it is taught to use the tetragonal phase of the BSCCO 2212 oxide superconductor in the formation of the multifilament wire, which then is phase converted in a high temperature process into orthogonal phase BSCCO 2212 prior to texturing. See, U.S. Pat. No. 5,942,466, entitled “Processing of (Bi,Pb)SCCO Superconductors in Wires and Tapes,” for farther details. In at least some embodiments, the present invention heat treatments that may prematurely form the high resistivity metal oxide are avoided. Therefore, at least some embodiments of the present method use the orthorhombic BSCCO 2212 phase from the beginning of the process so that no high temperature heat treatment is required once the predecessor metal foil composite is assembled. In at least some other embodiments, the tetragonal BSCCO 2212 phase may be used and the heat treatment is modified accordingly.

The resultant strand desirably has a cross-sectional aspect ratio of about 1:1 to 7:1, and more preferably about 2-4:1. Lower aspect ratios provide lower ac losses and easier cabling. In at least some embodiments of this invention, no heat treatments are applied during the strand forming stages of the process which might result in oxidation of the reactive metals of the composite or formation of intermetallic compounds.

During the foregoing consolidation, deformation and texturing steps, the predecessor metal is co-deformed with the oxide superconductor filaments. The metallic layer is thinned during these operations and some level of physical breakdown, e.g., perforations, may occur; however, no significant destruction of the layer occurs if the layer has a ductility on the order of silver matrix.

In at least some embodiments, the strand is cabled immediately at this stage, indicated as step 150. Details of the cabling operation are discussed herein below. In at least some embodiments, the strand is subjected to a series of heat treatments (step 160) which oxidize the reactive elements in the alloy matrix to form ODS silver, and which oxidize the predecessor metal of the high resistivity layer. The heat treatments also form the bridges of the high resistivity regions. Some conversion of the precursor oxide to the final oxide, e.g., conversion of BSCCO 2212 into BSCCO 2223, may take place as well. In at least some embodiments, the starting superconducting phase is the final BSCCO 2223 phase, so that no further phase conversion is necessary. The oxidation process also aids in sinter-bonding adjacent strands in a cable configuration, if the strands have been cabled prior to oxidation.

In step 150, oxygen diffuses through the silver matrix, oxidizing the predecessor metal to form the dense oxide layer of the high resistivity region, the oxides of ODS silver (where present) and the higher resistivity ODS silver of the jelly roll configuration (where present). Oxygen transport rates may be enhanced by addition of suitable elements to the predecessor metal. For example, Na, K, Li, Ca, Sr, Ba, or Mg, may be added in relatively small amounts to enhance oxygen transport through the oxide.

In at least some embodiments, the high resistivity layer is formed without altering the composition of the precursor oxide to the oxide superconductor. Relatively low temperature, high-oxygen pressure processes have been reported for oxidizing metal precursors within silver. The process has the advantage of controlling the diffusivity of the predecessor metal so as to limit its diffusion into the surrounding metal matrix, which helps promote a dense oxide layer. See, U.S. Pat. No. 5,472,527, entitled “High Pressure Oxidation of Precursor Alloys,” for further detail, hereby incorporated by reference. In such an exemplary process, the strand is heated at temperatures in the range of 200-300° C. under oxygen partial pressures in the range of up to about 500 atm.

During oxidation, metal elements of the predecessor metal tend to migrate out of the metal predecessor and into the silver matrix, where they are oxidized and form an oxide precipitate in the matrix. The high oxygen pressure process limits the extent of metal migration so that the oxide precipitate forms immediately adjacent to the high resistivity region (i.e., the former metal predecessor region). As noted above, steps are taken to minimize the physical breakdown of the predecessor metal or oxide layers, e.g., selection for its ductility and co-deformability with the silver sheath; however, some defects do form. The formation of oxide precipitates immediately adjacent to the high resistivity layer provides a bridging region of intermediate resistivity.

In addition, subsequent processing may further degrade the now brittle high resistivity region, which results in gaps in the high resistivity layer. Oxide precipitates are available to bridge those gaps. In at least some embodiments, the oxidized multifilament article is subjected to a low strain deformation, e.g., 5-15%, in order to purposely introduce gaps or breaks into the high resistivity layer. The extent of the strain may be selected to introduce the number or level of material failure adequate to provide the desired volume percent bridges into the article. The adjacent oxide precipitates form bridges between the high resistivity regions. Thus, it is possible to subject the composite to significant deformation stresses—stresses which might otherwise compromise the integrity of the metal predecessor layer; while still obtaining a composite with low ac loss.

In at least some embodiments, the predecessor layers are oxidized at temperatures slightly greater than would be minimally needed to oxidize the layer. Particularly in the case of aluminum, this results in intermetallic formation. The intermetallics represent yet another composition of intermediate resistivity occupying the bridging regions of the high resistivity layer. By way of example, when the predecessor layer includes aluminum, the oxidation may be carried out in a temperature range of 450-600° C.

If the strands have not been previously cabled, they may be cabled at this point prior to oxide superconductor formation. In at least some embodiments, cabling takes place after final oxide superconductor formation, e.g., BSCCO 2223 formation, and before the final heat treatment.

In step 170, the oxidized composite is heat treated to form the oxide superconductor from the oxide precursor powders. In the BSCCO system, this involves the conversion of BSCCO 2212 and secondary phases BSCCO 0011 into the high Tc phase BSCCO 2223. Phase conversion of BSCCO 2212 into BSCCO 2223 may be carried out over a wide processing range. In at least some embodiments, processing conditions include heating the article at a temperature of substantially in the range of 815° C. to 860° C. at a P_{O2} substantially in the range of 0.001 to 1.0 atm. The exact processing temperature may vary dependant upon the oxygen partial pressure and the total overpressure of the system. In at least some embodiments, the oxygen partial pressure is in the range of 0.001-1.0 atm; and may be in the range of 0.01-0.25 atm. In the cabled architecture, this also sinters (bonds) adjacent strands, as the contacting silver surfaces sinter well under oxide superconductor forming conditions (T>800° C.).

In at least some embodiments, processing of the BSCCO 2212 (plus secondary phases) precursor into BSCCO 2223 is accomplished under conditions, which partially melt the oxide such that the liquid co-exists with the final oxide superconductor. During the partial melt, non-superconducting material and precursor oxide phases melt and the final oxide superconductor is formed from the melt. The heat treatment thus is conducted in two steps, in which (a) a liquid phase is formed such that the liquid phase co-exists with the final oxide superconductor; and (b) the liquid phase is transformed into the final oxide superconductor.

The above process has been found to advantageously heal any cracks or defects, which may have been introduced into the oxide superconductor filaments, particularly during any deformation operation. The liquid is believed to “wet” the surfaces of cracks located within and at the surfaces of the oxide grains. Once the conditions are adjusted to transform the liquid into the final oxide superconductor, oxide superconductor is formed at the defect site and “heals” the defect. In an exemplary method, the processing conditions are first adjusted to bring the article under conditions where a liquid phase is formed. It is desired that only a small portion of the oxide composition be transformed into a liquid so that the texturing introduced in previous steps is not lost. In the BSCCO system, in general a temperature in the range of 815-860° C. may be used at a P_{O2} in the range of 0.001-1.0 atm. In at least some embodiments, conditions of 820-835° at 0.075 atm O₂ are sufficient. The processing parameters may then be adjusted to bring the article under conditions where the liquid is consumed and the final oxide superconductor is formed from the melt. In general, a temperature in the range of 780-845° C. may be used at a P_{O2} in the range of 0.01-1.0 atm. In at least some embodiments, conditions of 820-790° C. at 0.075 atm O₂ is sufficient. See, U.S. Pat. No. 5,635,456, issued Jun. 3, 1997 and entitled “Processing for Bi/Sr/Ca/Cu/O-2223 Superconductors,” which is hereby incorporated by reference, for further details.

Conventional BSCCO 2223 tape processing employs rolling between different heat treatment steps; however, post-oxidation strands and/or cables of the invention are prone to shatter after oxidation because of the brittle, high resistivity oxide region is prone to shattering. Post-conversion rolling of a composite containing a high resistance oxide layer according to the prior art does not result in a composite having the high interfilament resistance of the present invention.

In at least some embodiments, a similar low reduction deformation (step 180) after heat treatment may be used to redensify the oxide superconductor phase and improve J_{c}. Such low reduction deformations are on the order of 0-15%, and preferably 3-15%, and most preferably about 5-10% thickness reduction. An intermediate, low strain deformations densifies the oxide without compromising the integrity of the high resistivity layer and is selected to prevent significant break-down (shattering) of the high resistivity region. It also serves to introduce gaps in the high resistivity layer, which may be filled with bridging material available from adjacently precipitated oxide or intermetallic formed during the oxidation step of the predecessor layer. The bridging material is co-deformed with the oxide layer in the intermediate deformation step 180, thereby pressing or forcing oxide precipitates formed earlier in the process, i.e., during previous oxidizing step 160, into the evolving gaps in the high resistivity layer.

In at least some embodiments, the phase converting heat treatments may be coupled with mechanical or hydrostatic constraint of the article, which mimics the positive effects of rolling without applying mechanical forces that disrupt the oxide layer. The constraining force may be uniaxially applied, i.e., in a single direction, or it may be isostatically applied, i.e., uniform in all directions. In at least some embodiments, uniaxial pressure, e.g., hot pressing, is applied to maintain density and texture in the plane or direction of elongation. In at least some embodiments, an isostatic pressure is used as the constraining force. When used at elevated temperature conditions, the process is known as hot isostatic pressing (HIP). In at least some embodiments, pressures may be in the range of about 10-2500 atm (1-250 MPa), and preferably about 25-100 atm (2.5-10 MPa). Improvements in density and texture retention during phase conversion have been observed for pressures in the range of about 40-85 atm (4-8.5 MPa). Pressure is applied at a temperature and an oxygen partial pressure that facilitates phase conversion of the precursor into the oxide superconductor. Further detail is provided in co-pending application U.S. Ser. No. 09/665,882, filed Sep. 20, 2000, and entitled “Simultaneous Constraint And Phase Conversion Processing of Oxide Superconductors,” which is hereby incorporated by reference.

Additional processes are contemplated within the scope of the invention, dependent upon the intended use of the conductor. For example, in high stress applications it may be desirable to laminate the conductor onto a stainless steel strip after the final reaction step. This may be accomplished using an adhesive solder or direct sintering.

In at least some embodiments, cabling is carried out after texturing deformation (step 140) and prior to formation of the desired oxide superconductor (step 170), and/or prior to oxidation to form the high resistivity material (step 160), or after step 180 rolling to redensify the superconductor (but prior to the final heat treatment). The method is scalable to large scale manufacturing techniques and high packing factor cable designs. Strands formed as described may be cabled at high packing factors on conventional cabling equipment such as that supplied by the Entwhistle Company of Hudson, Mass. Planetary or rigid cabling equipment may be used. A Rutherford-type cable is preferred. This is a type of generally rectangular, compacted Litz cable whose general assembly parameters are well known in the art. However, any type of cable, such as a partially transposed cable, or the Roebel or braided forms of Litz cable may be used. The strands may be manufactured in accordance with the cabling parameters generally specified for the particular piece of equipment. Typical parameters for a Rutherford cabling machine are described in connection with the bismuth example discussed below.

Generally, the cable may be manufactured in accordance with the invention by the transposing the multifilament strands disclosed herein about the longitudinal axis of the cable at a preselected strand lay pitch. By “strand lay pitch” is meant the longitudinal distance displaced by a strand as it completes a single turn. Typical lay-up pitches are less than 50 cm, and preferably in the range of about 2 to 20 cm, and more preferably in the range of about 2 to 5 cm.

In at least some embodiments, strands are planetary Rutherford cabled in a 2×n configuration. In at least some embodiments of the present invention, cabling includes hard direction edge bending of the strands; however, low aspect ratio strands may be cabled without undue stress on the strands, in particular, if the lay-up is relatively loose. Typically two or more strands are cabled with the typical numbers in the range of 4 to 40, depending upon the required current capacity of the low loss conductor; however, up to 500 strands may be used. The typical cabled cross-section may be in the range of 0.004 to 1 cm².

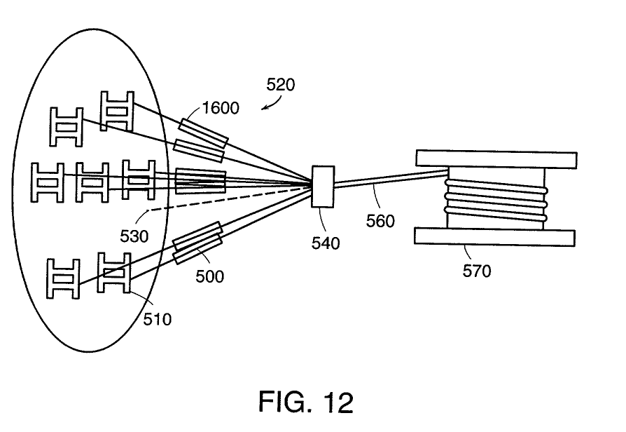

In at least some embodiments, the strands may be layed-up by planetary winding. In accordance with the invention and with reference to FIG. 12, the strands 500 to be transposed are spooled in equal amounts onto N spools 510, where N is the number of strands to be included in the cable. These spools are loaded onto the cabling machine 520. Each spool has an independent tensioning device to provide uniform tension control on pay-off (not shown). The applied strand tension is preferably less than 0.2 of the tensile strength of the strand. The spools rotate together about a common rotation axis 530. In the machine shown in FIG. 12, a planetary control provides the capability to rotate the spool through its centroid about an axis parallel to the rotation axis. In this configuration, the same side of the strand always faces the same direction in the cable, i.e., the strand orientation is invariant. However, the invention may also be practiced on rigid cabling machines, which do not provide such capability.

In at least some embodiments, the strands may use tool 1600 to pre-edge bend the strands. Pre-edge bending helps minimize damage to the strand, and speed the rate of cabling. In at least some embodiments, the strands may be edge bent during lay-up.

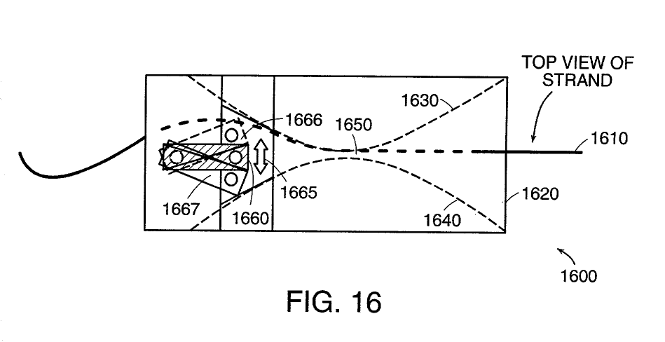

With reference to FIGS. 12 and 16, an edge bending tool 1600 is positioned between spools 510 and gathering point 540 to pre-bend the strand into an s-shape that corresponds to the strand lay pitch of the cable. The edge bending tool 1600 includes opposing plates, which constrain a strand 1610 in the thickness direction, so that the strand is viewed from the flat face in FIG. 16. Bottom plate 1620 is shown in FIG. 16; however, the top plate is removed for clarity. The top and bottom plates are spaced apart from one another using shim 1630, 1640. The shims extend inwardly to form a gap 1650 through which the strand is fed. The shims may be curved to facilitate the procession of the strand through the gap and to aid in the introduction of the bend or curve of the appropriate curvature into the strand.

As the strand exits the gap, it contacts a bending guide 1660, which is movable in the direction of arrow 1665 between position 1666 proximal to bending guide 1630 and position 1667 proximal to bending guide 1667. The bending tool is also capable of up-and-down movement, which raises the tool into and above the plane of the strand. Edge 1670 of the bending guide may be curved and is may have a radius of curvature complementary to that of the shims 1630 and 1640.

In operation, strand 1610 is fed into the tool 1600 and through the gap 1650 from a position distal to the bending guide 1660. The bending guide, which is initially in a neutral position, engages the strand so that the strand passes along one side of the guide (e.g., the upper side as viewed in FIG. 16), in which the strand passes between the guide and the shim. The bending guide moves to a first position 1666 to bend the strand into a curve defined by shim and the curved portion of the bending guide. The bending guide then releases the strand, which advances through the tool. The guide then is raised above and over the advancing strand, so that the strand passes along the other side of the bending guide (e.g., the lower side as viewed from FIG. 16). The bending guide then moves to a second position 1667 to bend the strand into a curve defined by shim and the curved portion of the bending guide. The curve is opposite that introduced in the first bending step.

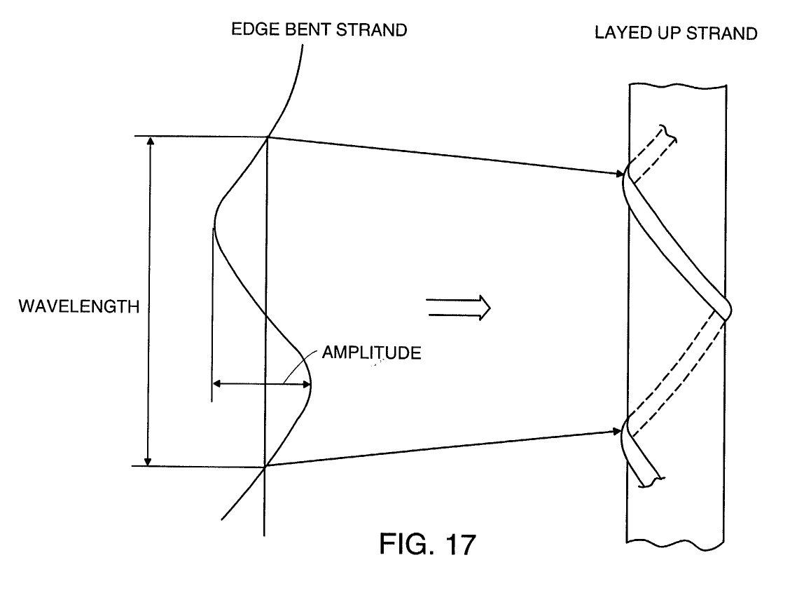

The resultant strand now has an “s”-curve possessing and both an amplitude and a wavelength, as is shown in FIG. 17. The amplitude is a function of the width of the cable, and in particular, a function of the width (and shape) of the former, if one is used in the cabling operation. The wavelength is a function of the lay up pitch of the strand. The strand lay-up (distance along the cable axis traversed by a strand in making a full circle about the x axis) is about 2 to 10 times the twist pitch of the individual strand filaments, or in at least some embodiments is less than 100 cm, or less than 50 cm, or, in at least some embodiments, is less than 20 cm or, in at least some embodiments, is in the range of 3-15 cm. The radii of the s-shape may range from about 2 cm to about 100 cm, and the sweep of the arc defining one-half the s-curve may have a range of about 0.5°-20°, or in some embodiments, about 1°-10°. Thus, it is possible to define the resultant cable properties in the pre-edge bending step, as is illustrated in FIG. 17B. Pre-edge bending improves the electrical properties of the resultant article because the damage upon bending is reduced and because the strand may be bent to the desired shape without bowing or buckling, which negatively alters strand orientation in the planetary winding. Furthermore, pre-edge bending permits a higher strand packing factor than cables prepared without pre-edge bending. In at least some embodiments, strand packing is greater than 75%, and in at least some embodiments, strand packing is in the range of 80-90%. This may be compared to strand packing of 50-70% commonly observed in the planetary winding of oxide superconductor strands.

Once the strand is edge-bent, it may be taken up in planetary cable. Referring again to FIG. 12, each of the spools pays off to a “gathering point” at a fixed position from the mandrel (not shown) and approximately circumferentially symmetric about the mandrel. The mandrel is a spade-shaped tooling that is non-rotating and located on the common rotation axis. The strands wrap around the mandrel and pay-off into a shaping Turk's-head roll 540 (or other consolidating means which does not highly aspect the cable) that defines the cable width and thickness. The rate that the cable is pulled through the Turk's-head relative to the rotation rate around the common axis defines the cable lay pitch. The resulting cable 560 may be taken up on a mandrel or spool 570.

Alternatively, a former may be used to assist in strand lay up. In at least some embodiments, a high resistance central former, metal or ceramic, may be used to assist in cabling, which has the further advantage of reducing ac losses if it is retained in the conductor to become an integral part of the cable architecture. The cable may be consolidated with the former during the sintering reaction by bonding of contacting silver surfaces of adjacent strands, or other reactive material of the surface that sinters or bonds the strands together. The strands must of course be in a condition that allows for thermally active bonding in order for this to occur. For example, the strands may have a silver or silver alloy outer surface, or another noble metal, or a ceramic or glass that is capable of softening and sintering under heat treatment conditions.

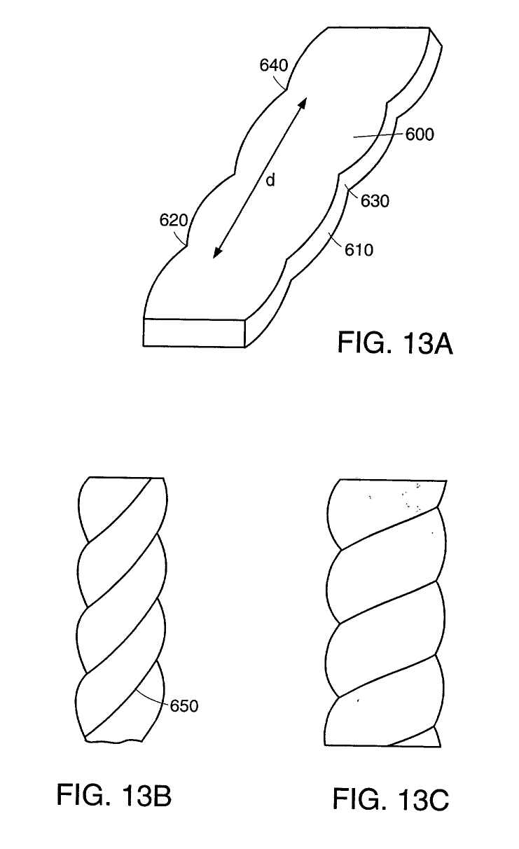

The former may be in a variety of shapes, but is preferably in a flattened tape configuration. A novel former has been developed, which significantly improves the ease of cabling and the quality of the resultant cable. In at least some embodiments, a former has surface features, which aid in the lay-up and edge bending of the strands. Referring to FIG. 13, a former 600 may have curved or scalloped edges 610 running along its longitudinal thin dimension. The curving feature minimizes the angle at which the strand needs to bend in order to wrap around the former and thereby eases stress, e.g., bending strain, in the strand on lay-up. The curved edge of the former also guides the strand about the former and urges it in the desired direction as it is transposed about the flat surface of the former. For even number of strands, the curved edges are substantially symmetric about the core center line (FIG. 13B), whereas for odd number of strands, the bulging shapes are exactly out of phase with each other on the opposing edges of the former (FIG. 13C).

The distance d between opposing edges of adjacent scalloped features of the former define the strand lay-up. The strand is wound from the lower scallop edge 620, across the upper flat surface of the former to opposing scallop edge 630, and then under the flat former surface to upper scallop edge 640. Suitable selection of a former with the appropriate scalloped edges aids in obtaining the desired strand lay-up. The angle of curvature of the scallop feature defines the degree of bend that the strand will experience as it is wrapped around the edges of the former. The more curved the scallop feature, the more gradual the bending and the lower the edge-bending stresses experienced by the strand. In at least some embodiments of the invention, the flattened tape surface of the former is not completely flat, but rather is scored with raised lines or ridges 650 that help to guide the strands during lay-up.

According to one aspect of the invention a method is provided for making the formers of any scallop dimension and/or curvature needed to attain the desired winding features of the cable. The central former may be prepared from rod having a variety of cross-sectional geometries, such as square, pentagonal, hexagonal and higher sided shapes. The sides are preferably of equal dimension. The rod is then twisted so that the twist pitch of the rod is about the dimension desired for strand lay-up. The twisted rod is then rolled to tape to form a flat former having bulging, curved edges and surface tracks leading from one side of the former spirally to the other side of the former. The lay up pitch then follows the rolled twist pitch of the rod. The rod shape and twist pitch are variables which may be adjusted to obtain the desired lay-up pitch.

As previously discussed, the as-formed cable is typically not deformed prior to sintering so as to minimize damage to the internal oxide structure. However, during final sinter reaction to form the oxide superconductor, the cabled conductor may be pressed mechanically using co-wound metal strips or hydrostatically by gas or liquid pressure.

The invention is illustrated by the following examples which are presented for the purpose of illustration only and are not intended to be limiting of the invention, the full scope of which is set forth in the claims which follow.

Measurement of ac loss properties. There are several ways of characterizing ac loss from inductive effects. The most direct definition and method of measurement relies on direct measurement of the total power dissipated from the conductor at operating conditions, and this is most directly measured using a calorimetric method with time-varying transport current and ac magnetic field conditions. Ac loss may also be measured by magnetic methods in the absence of current transport. The operating current density and ac loss are not independent of one another, since the attractiveness of oxide superconductor ac conductors are their ability to transport greater AC or DC current densities than convention conductors with less power dissipation in a time-variant magnetic field.

Ac loss is obtained by dividing the measured power per unit length by the dc transport current (four point probe transport method using 1 μV/cm criterion) measured at the dc perpendicular field corresponding to the peak field of the loss measurement. An alternative and commonly employed method of characterizing ac loss consists of deducing the power dissipation due to induction without transport current using ac magnetic field excitation of the superconductor. The induced voltage is measured in pick up coils surrounding the superconductor. The greater the induction in the superconductor, the greater the loss and the greater the shift in the induced voltage form and amplitude in the pick up coil. This method yields ac loss in terms of power at a specific frequency with field amplitude varied over the range of interest at T>T_{c}. In the losses reported by this method herein, the calculated power per unit length form the induction data was multiplied by the √2/DC I_{c} in the field at RMS field level. This provides additional insight into the loss values under transport conditions.

Practically, when considering ac inductive losses, one is interested in the power generated per unit conductor volume at operating conditions, including transport current. Although the operating field and temperatures are important, the temperature can be lowered to impact the current potential of the wire at a certain loss level, with refrigeration cost weighing in as a practical opportunity cost for the higher current gains. Of course, the field levels also set the possible operating current levels. Devices are designed for operation at maximum possible fields allowed by maximum current, mechanical properties and the like.

Jₒₚ is the operating current density (at ac field, temperature conditions) that can be sustained such that the losses (energy dissipation from the superconductor) do not exceed the target or specific ac loss levels identified for the device. Although typically, Jₒₚ would be set by the requirements of the device, the most direct way of measuring Jₒₚ (dissipation, operating field, operating field ramp rates and operating temperature) for a conductor is to measure loss at operating field, field ramp rates and temperature, as a function of transport current in for example a calorimeter. When the maximum allowed loss (dissipation) level is identified, this is an indicator of the maximum operating current density, Jₒₚ. From this data, it is possible to select lower Jₒₚ values for margins of safety, and so forth.

An alternative, and simpler, way to determine Jₒₚ is to measure the ac I-V curves for the conductor at operating temperature and magnetic field conditions. A magnetic loss measurement on the same material will provide inductive losses (ac) and transport current related loss, giving the total, from which the operating current can be derived at a total allowable level of power dissipation.

Alternatively and most practically at present, DC I-V data is obtained over a wide range of electric field levels in increasing DC magnetic fields, and the effect of the ac field is estimated based on the following relationships. First, the ac power that would be dissipated based on the DC data is estimated by taking the DC I-V curve and multiplying Pᵣ˜I(DC)×V(DC)×1.414 at the peak magnetic ac field, or some reduced value of the maximum field. Then, the inductive loss (Pᵢ(B, f, T)) is estimated by doing inductive loss measurements. Combining the two data sets gives to total power, Pₜ˜Pᵣ+Pᵢ, which can be solved for I(DC) at fixed Pₜ. As a first guess in our work, Pᵢ was assumed to be about ½ the total loss level if we operated at about 1 μV/cm field, from which Iₒₚ and Jₒₚ could be deduced

Filament-to-filament resistance is the measured resistance experienced in a multifilamentary article when current flows from one filament to another. Interfilament resistance is measured across filaments using the well established four point probe transport method using 1 μV/cm criterion, or analyzing loss data.

### EXAMPLE 1

This example describes the preparation and characterization of a multifilament strand.

Preparation of a monofilament rod. Monofilament bundling rods were fabricated according to the following method.

Silver and silver alloy (e.g., Ag—Mg alloy with up to 0.6 wt % Mg) rods cut to length were cleaned in solvents, etchants and via mechanical abrasion including filing. In a clean environment, the rods were then wrapped with thin, high purity metal foils, typically either aluminum, nickel or copper. Typical thicknesses of aluminum investigated covered the range of about 30 to 1000, where this number is the ratio of rod diameter divided by the total foil thickness on the rod surface. The main focus was on aluminum as the predecessor to the aluminum oxide filament de-coupling layer. The foil-wrapped rod was then inserted into an appropriate extrusion billet composed of pure silver or a silver alloy so that the foil-enclosed area was about 1 to 5 times larger than the cross-sectional area of the billet walls. Exemplary filament strands were prepared using aluminum foils of varying thickness (0.003″ and 0.0015″) to form the high resistivity region. Aluminum foil thickness was in the range of about 1/375th and 1/750th, respectively, of the total enclosed region (silver matrix).

A tail cap was then attached by welding, gluing and in some cases, soldering, followed by evacuation. In the case of aluminum, the evacuation was completed in the 100° C.-200° C. temperature range in order to inhibit intermetallic formation. The evacuation stem was then crimped, and the billet extruded to cylindrical rod at conditions from ambient temperature up to about 500 C., thereby consolidating and metallurgically bonding the separate elements of the billet. In the case of aluminum, extrusion was completed at ambient, with the heat of work (200° C.) dissipated by a rapid quench applied immediately after extrusion. Extrusion reduced cross-sectional area typically by a factor of 1.5 to 8.

The metallurgical bonding could also be attained by other methods such as drawing and annealing, however with aluminum it is more difficult to avoid intermetallic formation with these methods. Such techniques may be more practical for metal solutes less prone to intermetallic formation with silver, e.g., nickel.

The extruded rods were then cut to the desired lengths, and concentric holes were drilled to form a cavity in each piece. After cleaning of these “powder” billets, BSCCO 2223 precursor powder, consisting of BSCCO 2212 and reactants required to form BSCCO 2223, were then packed into the cavities, followed by gluing, welding or soldering of tail caps, and evacuation through stems in the tail caps. In the case of aluminum, evacuation was completed at <200° C. in order to avoid silver-aluminum intermetallic formation. This evacuation step could also be eliminated if the powder is suitably baked out followed by packing in an inert environment free of water vapor and carbon dioxide. These powder billets were then deformation processed, typically by drawing, to the desired shape for bundling into multifilament architectures.

Annealing in a non-oxidizing environment was commonly employed to ensure good ductility in the metal constituents of the powder billets, however, the aluminum-containing billets were either not annealed, or annealed at temperatures below about 200° C. in order to avoid intermetallic formation. Two drawn shapes were made, hexagonal, and a space filling trapezoidal shape with curvature of the parallel surfaces, i.e., a truncated pie-shape shown in FIG. 10A.

Multifilament wire fabrication. A multifilament strand was prepared as follows.

The mono-cored rods were cut to the required lengths, and cleaned. They were then arranged into the bundle shape, and inserted into the cavity of another silver or silver alloy billet. However these billets did not contain predecessors to de-coupling layers. The packed billets were then deformation processed, typically by drawing, to form round wires in the 0.25 to 2 mm diameter range.

In order to bundle these latter shapes, a central round rod was also drawn of the same material. It was determined that the truncated pie-shaped rods (FIG. 10A) gave particularly good results. The pie shape provided high packing efficiencies without much distortion of the rod. FIG. 10B is a photomicrograph of the cross-sectional area of such a bundled rod after consolidation. The sample shown is a 12 filament multistrand having a 0.19 wt % Al—Ag outer layer. Pure silver was used for the core and the inner sheath region adjacent to closest to the oxide filament. The aluminum foil had a thickness ratio of 750:1.

Note that the walls of the individual monofilaments remained intact and well-defined. By enabling consolidation and shape reduction without significant distortion of the individual element features of the monofilament, the precursor metallic foil remains intact. This results in a higher quality high resistivity layer and reduced material failure, e.g., reduced filament merger in the resulting multifilament article. In addition, the pie shape permits bundling at higher filament numbers than the more traditional hexagonal rod. For example, a bundle of hexagonally-shaped monofilaments can accommodate at most 7 filaments, while the pie shape example of FIG. 10B easily accommodates 12 filaments and may include more by modification of the pie angle.

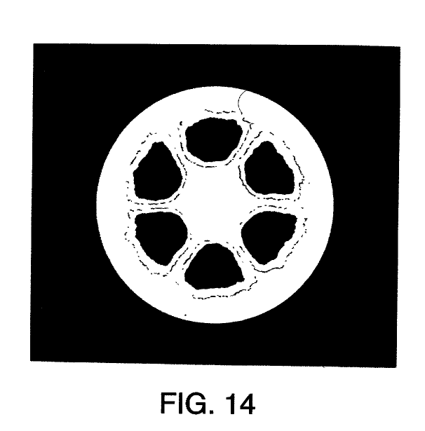

FIG. 14 shows a consolidated multifilament using hexagonal monofilament rods. This sample is a 6 filament multistrand having a 0.21 wt % Mg—Ag matrix throughout the sample. The aluminum foil had a thickness ratio of 375:1. While the foil layers remain intact and distinct from the oxide filament, note the large change in overall geometry from the starting hexagonal cross-section.

Some wires were twisted by drawing through a final die while the take-up rotated about the wire axis as it exited the die. Although twisting has been commonly employed and described in the prior art, another appropriate method consisted of twisting the wire locally to about 360 degrees about its axis, followed by a reversal of the rotation direction and rotation back zero degrees, and repetition of this motion as the wire was pulled through a pair of dies. The first die then acted as the anchor, and the second was oscillated about its axis in the manner described to impart this oscillating pitch. This method provided for the added benefit of allowing direct feeding into the rolling step, thereby combining the two process steps.

After twisting, some wires were also drawn to specific square, rectangular or hexagonal shapes. These and the round wires were then rolled to texture the BSCCO 2212 predecessor to BSCCO 2223, as well as densify the powder aggregate. Narrow, relatively low aspect strand was made by rolling the wires with small diameter rolls (for example roll diameters that were about 8 to 15 times the wire diameters), and by the constrained method that is the subject of U.S. Pat. No. 5,885,938, hereby incorporated by reference.

In yet another method, wires of comparable diameter to the BSCCO wire were co-rolled beside the central BSCCO wire, thereby reducing the amount of lateral spreading of the wire, even when relatively large diameter rolls were used. Rolling with minimal lateral spread was typically to thickness reductions of about 55%-75%, as opposed to the more conventional >75% range for rolling of high aspect BSCCO tape.

Oxidation of the predecessor metal to form the high resistance de-coupling layers.

The predecessor metals, aluminum, copper in silver were internally oxidized by diffusion of oxygen into the composite from the wire surface either in the early stages of the first heat treatment employed to form BSCCO 2223, or as a separate step. The methods found to work included heat treating at up to 600° C. in high-pressure oxygen-bearing gas (with oxygen partial pressures to ˜150 atm), as well as heating in oxygen-bearing gas at 1 atm total pressure and oxygen present at partial pressures of 0.07 atm to 1 atm. Oxidation could be completed either via slow temperature ramps or dwells at specific temperatures.

Formation of sintered BSCCO 2223, and de-coupling layers with bridges. The reaction step for BSCCO 2223 formation followed the well known step consisting of a first 820° C.-839° C. bake in 0.075 atm oxygen for 15 to 40 hours, followed by cooling to ambient. A small-strain rolling step (5-10% strain) at this point is used to introduced some bridges into the aluminum, or copper oxide layer, and to densify and texture the already-formed BSCCO 2223. The best results were obtained with thicker aluminum layers containing about 10% vol/vol bridges by area in the fully reacted aluminum oxide layers as determined by image analysis. The composition of these regions is of a higher resistivity than the matrix composition due to aluminum migration and oxidation in the bridging region.

The formation of BSCCO 2223 was then completed according to the commonly employed method (a multi-temperature heat treatment consisting of dwells at about 820-835° C., 800-819° C., and 700-750° C. in about 0.075 atm oxygen bearing gas).

FIG. 10C is a photomicrograph of the material shown in FIG. 10B, after formation of the oxide superconductor multifilament is complete. The high resistivity layer was formed by heating for two hours at 430° C. under high pressure oxidizing conditions. Even after oxidation, texturing rolling and oxide superconductor formation, the pie-shaped monofilaments retain their form and the alumina decoupling layer is intact and well-defined.

### Characterization

Nominally 5 cm long samples were characterized for transport I_{c} at 77 K both in self and externally applied DC magnetic field, in both the perpendicular and parallel field directions using a four point method, and 1 μV/cm field criterion. Ac loss measurement were then completed on select samples with magnetic induction methods at 77 K, and occasionally 64 K, in 50 Hz ac magnetic fields varied from about 3 mT to 50 mT, with the field oriented in the perpendicular direction. The frequency dependence of ac loss was also measured for some samples. The typical sample length for loss was 4 cm, and the sample ends were polished (with 1 micron diamond) so as to minimize short circuit pathways across high resistance layers near the sheared sample ends. This polishing reduced error in estimating long length loss characteristics using short samples.

Relatively small strain rolling after some of the BSCCO 2223 has formed is well known to increase the transport critical current density. As this rolling strain was increased, the ac loss of samples (in terms of mW/Am) typically decreased to a minimum for strains in the 5%-10% range, followed by gradual increases. At the same time, the transport critical current density increased continuously. Since the metal predecessor layer is already oxidized at this point, the rolling tended to introduce bridges across the oxide layer consisting of lower resistance silver alloyed with dispersed oxide particles. At relatively small strains, the bridges formed in the oxide did not adversely affect loss, while allowing the formation of better textured, more dense, and more phase pure BSCCO 2223. Beyond the minimum loss strain region, the bridges in the oxide became excessive, leading to increasing losses, illustrating the need for the optimal amount of bridging in the high resistance layer.

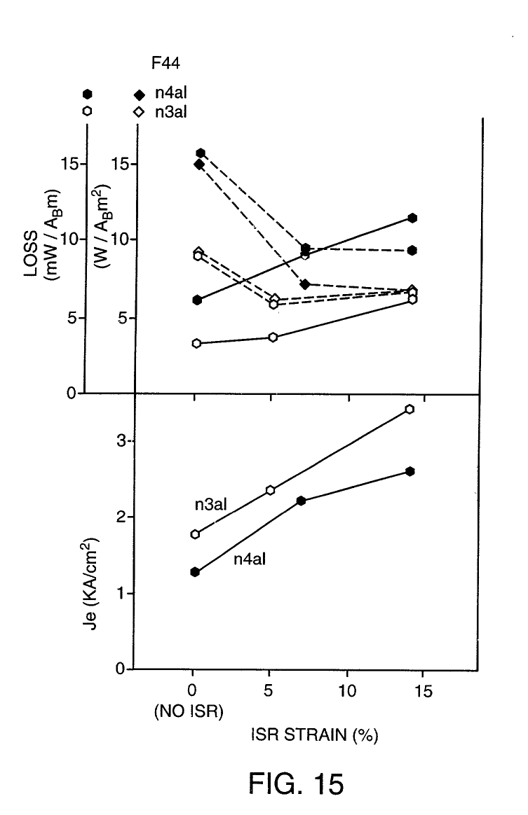

This trend is illustrated by the data in FIG. 15, which reports the loss results for samples prepared from the consolidated multifilament shown in FIG. 14. Solid data points are ac and Jₑ results for the sample shown in FIG. 14, having and alumina high resistivity region and a 0.21 wt % Mg—Al matrix throughout the strand. Open data points represent a similarly treated sample in which the inner sheath material is pure silver. Loss results are reported as either mW/A-m or W/A-m² and may be directly compared with the engineering critical current for the sample. Under optimal intermediate strain rolling conditions (ca. 5-10%), samples showed decreasing loss with increasing Jₑ. Note that these reported loss values have not been optimized and reduced losses are reported in the table below.

The utility of a superconductor for ac field applications at all field orientations depends on complex factors, and attributes. In fabricating the optimal wire, the conditions represent trade-offs between different attributes. For example, thicker predecessor layers provide for higher resistances between the filaments but increased difficulty in attaining required critical current density and total conductor levels. As well, the perpendicular field ac losses of conductors are known to decrease linearly as their widths decrease, hence narrower conductors with all else constant exhibit lower losses, albeit lower currents as well. One tactic for retaining Ic while reducing loss by reducing width is to also decrease the strand cross-section aspect. However, this is not easily accomplished without sacrificing Jc and Bi2223 texture.

As described above, strands were made with a variety of geometries silver alloy compositions, and oxide layer thicknesses. The primary means of comparing the performance characteristics of these wires is using the mW/A-m metric, along with the power dissipation per unit volume. Although loss was measured at many ac fields, covering field ramp rates from about 0.3 T/s to about 14 T/s (RMS fields of about 1 mT to 50 mT), the representative data here is at the aggressive field ramp rate level of 7 T/s. Some key loss results from a variety of samples are illustrated in Table 1.

TABLE 1
Examples of ac losses demonstrated for different filament configurations and
sheath compositions

| Example | 1 | 2 | 3 |
|---|---|---|---|
| Number of filaments | 7 | 6 | 13 |
| Configuration | Hex | Hex | Pie |
| Resistive layer predecessor | Yes | Yes | Yes |
| Predecessor material | Al | Al | Al |
| Thickness ratio | 1:375 | 1:750 | 1:280 |
| Sheath material | Ag | Ag | Ag |
| Initial | Ag | Ag | Ag |
| Final | Ag | Ag | Ag |
| Oxidation treatment (° C.) | ca430 | ca430 | ca430 |
| Post-oxidation rolling strain, % | 9.1 | 8 | |
| Strand attributes | | | |
| Width, cm | 0.052 | 0.086 | 0.094 |
| Thickness, cm | 0.0102 | 0.0122 | 0.0135 |
| Shape aspect | 5 | 7 | 7 |
| Twist pitch, cm | 1.16 | 1.5 | 1.3 |
| Ic(77K, 1 uV/cm, self field), A | 2.11 | 5.23 | 4.50 |
| Ic(77K, 1 uV/cm, 25 mT ⊥), A | 0.79 | 2.04 | 1.76 |
| Je(77K, self field), A/cm² | 4,000 | 4,970 | 3,580 |
| Je(77K, 25 mT ⊥) | 1,500 | 1,943 | 1,396 |
| Jc(77K, self field) | 22,200 | 27,600 | 14,900 |
| AC loss(25 mT ⊥, 50 Hz, 77K, ˜7 T/s) | | | |
| mW/A_{f}m | 1.17 | 2.68 | 3.8 |
| W/A_{f}m² | 2.25 | 3.12 | 4.04 |
| W/cm³ | 0.012 | 0.037 | 0.037 |

In assessing the utility of these loss and transport current levels, one benchmark comparison is to the losses of normal copper conductor. Firstly, copper at ambient temperature typically cannot be operated above about 200 A/cm, however, the cooling costs of the superconductor add cost, therefore at minimum an operating current density of at least 5 times higher is required. In actual superconducting devices, the multiplier is more typically 50 fold or greater. This can be accomplished with BSCCO 2223 by lowering the operating temperature from the 77 K test temperature, to for example 20 K, still exceeding the operating temperature of conventional low transition temperature superconductors by at least a factor of 2, and more typically, a factor of 4. For copper at ambient temperature (˜20 C.), the losses are dominated by the resistive component. At 100 A/cm² current density, copper exhibits a resistive loss of 16.7 mW/A-m or 0.0167 W/cm³. At 200 A/cm², its loss is 33.4 mW/A-m and 0.067 W/cm³. With resistance reduced at 77 K, copper at this comparable operating temperature to the superconductor, has net resistive losses of 0.016 W/cm³ and 8 mW/A-m at 200 A/cm², and 0.4 W/cm³ and 40 mW/A-m at 1000 A/cm²—greater then 10-fold the losses exhibited by the superconductor at similar or greater operating current densities. These numbers illustrate the current/current density/loss advantage of the superconducting wire of the present invention.

Several of the strand samples made via the invention were also measured for ac loss at a lower temperature, 64 K. It is found that the overall ac loss of the strand decreased by about 1.2 fold (in terms of mW/Am) while the current density at the benchmark 25 mT DC increased by about 1.6-fold. These data illustrate the improvements in current and loss attained by reducing temperature. Practical use of the superconductor at optimal conditions requires analysis for each application in terms of the increased performance and increased refrigeration cost associated with going to lower temperatures. This example illustrates that the conductor attributes attained via the present invention and characterized at 77 K for convenience truly provide utility for a very broad range of temperatures below about 0.9×Tc (where Tc is the zero field transition temperature for the material into its superconducting state), and as low as about 4 K—the boiling temperature of liquid helium.

### EXAMPLE 2

This example describes the formation and characterization of cabled articles. The ac loss performance of cables prepared from conventional multifilament strands and the filament decoupled strands of the invention are compared.

Comparison strands were prepared from BSCCO 2223 oxide superconductor filaments without filament decoupling layers (high resistivity regions) using a conventional monofilament hexagonal geometry. The mono-cored rods were cut to the required lengths, and cleaned. They were then arranged into the bundle shape, and inserted into the cavity of another silver or silver alloy billet. The packed billets were then deformation processed, typically by drawing, to form round wires. As indicated in Table 2, resistive material was used in some instances to coat the strands, i.e., a strand decoupling layer, which included an outer Ag layer to allow bonding together of the strands in the final heat treatment after cabling (samples C2 and C3).

Strands having filament decoupling layers (and optional strand decoupling layers) were prepared according to the methods described in Example 1 having a variety of silver alloy compositions and oxide layer thicknesses. The multifilament strands were prepared from truncated pie-shaped monofilaments of varying filament count.

The articles were cabled with or without a center former, as is noted in Table 2. In all cases the strands were planetary wound and were pre-edge bent prior to strand lay-up. Although loss was measured at many ac fields, covering field ramp rates from about 0.3 T/s to about 14 T/s (RMS fields of about 1 mT to 50 mT), the representative data here is at the aggressive field ramp rate level of 7 T/s. Some key loss results from a variety of samples are illustrated in Table 2.

TABLE 2
ac losses for different cable configurations and constituent strand attributes

| Article | C1 | C2 | C3 | C4 | C5 | C6 |
|---|---|---|---|---|---|---|
| Strand | | | | | | |
| Sample number | OX2076 | OX2076 | OX2076 | OX2076 | 82 | 84 |
| Resistive material | None | None | None | None | Al | Al |
| around filament | | | | | 1:280 | 1:750 |
| Resistive material | None | CuO/Ag | NiO/Ag | Rubber | No | NiO/Ag |
| around strand | | | | | | |
| Strand dimension | 0.1 × 0.3 | 0.1 × 0.3 | 0.1 × 0.3 | 0.1 × 0.3 | 0.017 × 0.112 | 0.023 × 0.091 |
| (cm) | | | | | | |
| Number of filaments | 19-hex | 19-hex | 19-hex | 19-hex | 13-pie | 12-pie |
| Strand AC loss: mW/A_{f}m | NA | NA | NA | NA | 8.6 | 9.1 |
| (25 mT ⊥, 50 Hz, 77K, ˜7 | | | | | | |
| T/s) | | | | | | |
| Cable | | | | | | |
| Cable sample | JGc13a | JGc13b | JGc13d | JGc13c | JGc6a | JGc7 |
| number | | | | | | |
| Number of above | 8 | 8 | 8 | 8 | 10 | 6 |
| strands | | | | | | |
| Center former | No | No | No | No | Yes | Yes-shaped |
| Center former | NA | NA | NA | NA | Cu-Ni-Al | Cu-Ni-Al |
| material | | | | | | |
| Cable AC loss: mW/m | 254 | 121 | 121 | 74 | NA | 31.2 |
| (25 mT ⊥, 50 Hz, 77K, ˜7 | | | | | | |
| T/s) | | | | | | |
| Cable AC loss: mW/A_{f}m | | | | | 27.2 | 18.2 |

The ac loss results reported in Table 2 show that the cable without resistive material around the strand (sample C1) had considerably higher loss(254 mW/Am) than the cables having either a CuO (sample C2)or NiO (sample C3) strand decoupling layer. The cable sample C4 was a control sample with strands rubber insulated, then glued together into the cable to illustrate how low the loss is when the strands are fully insulated from each other. This cable had the lowest loss of the C1-C4 related series, but only slightly lower then the samples with the CuO and NiO strand resistance layer. This approach however is not practical because there is no current sharing between strands and the cable therefore cannot function as a long length high current superconductor.

The transport I_{c} of cable C1-C4 in Table 2 with resistive materials around the strands could not be directly measured due to their short lengths. However magnetic measurements indicated that the critical currents of the strands in all cables was approximately the same.

Loss for cable C5 (architecture including filament resistance layers, and a center former, but no strand resistance layers) was measured in terms of mW/A_{f}m (normalized to I_{c}), because transport I_{c} could be accurately measured even for short cable samples. As expected, the cable loss is greater than the strand loss, with the cable loss about 4 fold greater, however with the loop sizes in the cable compared to the loop sizes in the strand, the expected loss in the cable without strand resistive layers is calculated to exceed strand loss by more than 10-fold. In comparison to the losses for non-coupled and strand-only decoupled cables, the filament decoupled cable C5 has a significantly smaller loss.

Cable C6 illustrates loss with center former, resistive filament and strand layers, with the pie strand architecture. Loss in each constituent strand is only one-half the loss in the cable although the cable contains 6 strand elements and loops providing greater than 10 fold the loops in the strand (loss is proportional to loop area). The strand losses for these strand samples compared to strand in Table 1 were somewhat higher due to the lower Je's in these strand samples. However they clearly illustrate the benefits of the strand resistive layers and the center former in cable AC losses. In comparison to the losses for non-coupled and strand-only decoupled cables, the filament decoupled cable C5 has a significantly smaller loss (31.2 mW/Am vs. 121 mW/Am).

Although various embodiments which incorporate the teachings of the present invention have been shown and described in detail herein, those skilled in the art can readily devise many other varied embodiments that incorporate these teachings.

What is claimed is:

1. A multifilamentary superconducting composite article comprising:
a plurality of oxide superconducting filaments in a conductive, ductile metal matrix arranged about a central core; and
a plurality of high resistivity regions embedded within and adherent to the conductive metal matrix, wherein a high resistivity region substantially surrounds each said oxide superconducting filament,
wherein each said high resistivity region comprises a substantially continuous phase of a high resistivity material having a bulk resistivity greater than 0.4 μΩ-cm interdispersed with bridges of a material having a resistivity intermediate to those of the conductive metal matrix and the high resistivity material.

2. The composite article of claim 1, wherein the article demonstrates a filament to filament resistance greater than 1×10⁻⁶ ohm-cm at T<T_{c}, where resistance is the four-point transport resistance between filaments multiplied by the measured sample length.

3. The composite article of claim l,wherein the ac power loss in a field perpendicular to the strand surface is less than 2.5 mW/A-m at greater than 0.01 T (RMS ac field, 30-300 Hz), as measured by magnetic methods without transport current.

4. The composite article of claim 1, wherein energy loss is less than 2.5 mW/A-m in a changing magnetic field at greater than 0.5 T/s, regardless of field orientation, as measured by magnetic methods without transport current.

5. The composite article of claim 1, wherein the article has a cross-sectional width in the range of 100-1500 μm and a cross-sectional thickness in the range of 30-500 μm.

6. The composite article of claim 1, wherein the article has a cross-sectional width less than 300 μm and a cross-sectional thickness less than 100 μm.

7. The composite article of claim 5, wherein the distance between oxide superconductor filaments is in the range of 10-100 μm.

8. The composite article of claim 1, wherein the oxide superconducting filaments are arranged about a central core selected from the group consisting of an electrically resistive core and an oxide superconductor core.

9. The composite article of claim 1, wherein the oxide superconductor filaments are arranged in a single concentric layer about the central core.

10. The composite article of claim 1, wherein the oxide superconductor filaments are arranged in two or more concentric layers about the central core.

11. The composite article of claim 1, the bridges comprise less than or equal to 20% vol/vol of the high resistivity region.

12. The composite article of claim 1, wherein the bridges comprise less than or equal to 10% vol/vol of the high resistivity region.

13. The composite article of claim 1, wherein the bridges comprise at least 0.001 % vol/vol of the high resistivity region.

14. The composite article of claim 1, wherein the bridges comprise at least 1.0 % vol/vol of the high resistivity region.

15. The composite article of claim 1, wherein the conductive matrix metal comprises silver and the material occupying the bridges of the high resistivity region comprises ODS silver.

16. The composite article of claim 15, wherein the conductive matrix metal comprises ODS silver and the material occupying the bridges of the high resistivity region comprises higher resistivity ODS silver.

17. The composite article of claim 16, wherein the oxide of the ODS silver is selected from the group consisting of Al, Mg, Ti, Si, Co, Ni, Zr, Hf and rare earth elements.

18. The composite article of claim 17, wherein the oxides are present in a volume % in the range of up to 5.0.

19. The composite article of claim 1, wherein the high resistivity material of the high resistivity region comprises a simple or complex oxide selected from the group consisting of nickel, lead, ytterbium, aluminum, copper and calcium.

20. The composite article of claim 1, wherein the high resistivity region has a thickness in the range of 0. 1 to 2 microns.

21. The composite article of claim 1, wherein the high resistivity region is in the form of a closed surface about the oxide superconducting filament.

22. The composite article of claim 1, where the high resistivity region is in the form of a sheet spirally wrapped around the oxide superconducting filament.

23. The composite of claim 1, wherein the high resistivity region has a honeycomb structure in which the high resistivity material comprises the honeycomb and the bridges occupy the spaces between the honeycomb.

24. The composite article of claim 1, wherein the article is comprised of 3-1000 oxide superconducting filaments.

25. The composite article of claim 1, wherein the article is comprised of 3-100 oxide superconducting filaments.

26. The composite article of claim 1, wherein the article is comprised of 6-18 oxide superconducting filaments.

27. The composite article of claim 1, wherein the oxide superconductor filaments have a cross-sectional aspect ratio of less than 8:1.

28. The composite article of claim 1, wherein the oxide superconductor filaments have a cross-sectional aspect ratio of about 2:1 to about 5:1.

29. The composite article of claim 1, wherein the article has a Jₑ of at least 3 kA/cm², self-field at 63 K.

30. The composite article of claim 1, wherein the article has a Jₑ of at least 5 kA/cm², self-field at 63 K

31. The composite article of claim 1, wherein the article has a Jₑ of at least 8 kA/cm², self-field at 63 K.

32. The composite article of claim 1, wherein the oxide superconductor comprises a bismuth-strontium-calcium-copper oxide (BSCCO) superconductor.

33. The composite article of claim 1, wherein the plurality of filaments are twisted about a longitudinal axis of the article.

34. The composite article of claim 33, wherein the twist pitch is in the range of 0.2 to 20 cm.

35. The composite article of claim 33, wherein the twist pitch is in the range of 0.2 to 3 cm.

36. The composite article of claim 33, wherein the oxide filament substantially surrounded by the high resistivity region does not merge with its neighboring filaments more frequently than once every twist pitch.

37. The composite article of claim 33, wherein the oxide filament substantially surrounded by the high resistivity region does not merge with its neighboring filaments more frequently than once every two twist pitches.

38. The composite article of claim 1, further comprising:
an outer high resistance layer substantially surrounding the outermost surface of the composite article.

39. The composite article of claim 38, further comprising:
a layer of material surrounding the outer high resistance layer, said material capable of bonding to similar materials.

40. The composite article of claim 39, wherein the material comprises silver.

41. A multifilamentary composite article serving as a precursor to an oxide superconductor comprising:
a plurality of oxide filaments in a ductile metal matrix, said oxide comprising an oxide superconductor or precursor thereto; and
a plurality of regions comprised of a predecessor metal to a high resistivity material embedded in and adherent to the metal matrix, and wherein a predecessor metal region substantially surrounds each said oxide filament, said predecessor metal having a plasticity on the order of the ductile matrix metal.

42. The article of claim 41, wherein the predecessor metal is selected from the group consisting of aluminum, copper, nickel ytterbium, lead, calcium, and alloys thereof.

43. The article of claim 42, wherein the predecessor metal comprises high purity aluminum and alloys thereof.

44. The article of claim 43, wherein the alloying metal is selected from the group consisting of Li, Na, K, Mg, Cu, Ca, Si and Mn, said alloying addition present in an amount less than 5 wt %.

45. The article of claim 41, wherein the predecessor metal region comprises a mixture or alloy of a metal and a fine particle ceramic.

46. The article of claim 41, wherein the predecessor metal region comprises in a metal mixture or alloy in a stoichiometry to form a complex oxide upon oxidation and reaction.

47. The article of claim 45, wherein the predecessor metal region a blend, mixture or alloy of barium and/or strontium with ZrO₂.

48. The article of claim 41, wherein the predecessor metal region comprises layers of different metals, each said layer of a thickness that provides a stoichiometry of a complex metal oxide.

49. The article of claim 48 wherein the region comprises at least three metal layers and a metal more reactive to silver is sandwiched between layers of less reactive metal.

50. The article of claim 41, wherein one or more metal elements of the high resistivity material is alloyed or mixed with the metal matrix.

51. A multifilamentary superconducting composite cable comprising:
a plurality of strands transposed about a longitudinal axis,
each said strand comprising a plurality of oxide superconducting filaments in a conductive, ductile metal matrix arranged about a central core; and a plurality of high resistivity regions embedded within and adherent to the conductive metal matrix, wherein a high resistivity region substantially surrounds each said oxide superconducting filament,
wherein each said high resistivity region comprises a substantially continuous phase of a high resistivity material having a bulk resistivity greater than 0.4 μΩ-cm interdispersed with bridges of a material having a resistivity intermediate to those of the conductive metal matrix and the high resistivity material.

52. The cable of claim 51, wherein the strands are transposed about a high resistance core.

53. The cable of claim 52, wherein the core is in the form of an elongated tape having periodic regions of wider and narrower width.

54. The cable of claim 52, wherein the cable is an aspected tape having 2 filament height and n filaments across, where n is in the range of 2 to 20.

55. The cable of claim 52, wherein the strands of the cable further comprise a high resistance layer substantially surrounding the outermost surface of the strands.

56. The cable of claim 51, wherein the bridges comprise a dispersed oxide-metal alloy.

57. The cable of claim 51, wherein the cable is comprised of two or more strands.

58. The cable of claim 51, wherein the cable is comprised of up to 500 strands.

59. The cable of claim 51, wherein the each said strand is comprised of 6-18 oxide superconducting filaments.

60. The cable of claim 51, wherein the cable has a cross-sectional aspect ratio of less than 10:1.

61. The cable of claim 51, wherein the cable has a cross-sectional aspect ratio of less than 4:1.

62. The cable of claim 51, wherein the cable has a Jₑ of at least 2 KA/cm², self field at 77 K.

63. The cable of claim 51, wherein the cable has an ac power loss in a field perpendicular to the strand of less than 50 mW/A-m at greater than 10 mT (RMS ac field, 30-300 Hz), as measured by magnetic methods without transport current.

64. The cable of claim 51 or 63, wherein the cable exhibits I_{c} of at least 100A, self field at 77 K, 1 μV/cm.

65. The cable of claim 51, wherein the cable demonstrates a filament to filament resistance greater than 1×10⁻⁶ ohm-cm at T>T_{c}, where resistance is the four-point transport resistance between filaments multiplied by the measured sample length.

66. The cable of claim 51, wherein the cable demonstrates a strand to strand resistance greater than 1×10⁻⁶ ohm-cm at T>T_{c}, where resistance is the four-point transport resistance between filaments multiplied by the measured sample length.

67. The cable of claim 51, wherein the oxide superconductor comprises a bismuth—strontium—calcium—copper oxide (BSCCO) superconductor.

68. A method of making a multifilamentary superconducting composite article, comprising the steps of:
forming an elongated multifilamentary composite comprising a plurality of oxide filaments in a ductile metal matrix, said oxide comprising an oxide superconductor or precursor thereto, and a plurality of regions comprised of a predecessor metal to a high resistivity material embedded in and adherent to the metal matrix, and substantially surrounding each said oxide filament, said predecessor metal region having a plasticity on the order of the ductile matrix metal.
processing the composite to reduce composite cross-sectional area and to induce texture in the precursor oxide filaments under conditions which substantially prevent oxidation of the predecessor metal and which maintain the physical integrity of the predecessor metal within the sheath;
oxidizing the textured composite to form a high resistivity material; and
converting the precursor oxide into an oxide superconductor, whereby a multifilamentary composite comprising a region of high resistivity embedded within and adherent to the metal matrix and substantially surrounding each said oxide superconducting filament us obtained.

69. The method of claim 68, wherein the step of forming an elongated multifilamentary composite comprises:
applying a layer of predecessor metal to a metal matrix core;
introducing a metal matrix sheath around the predecessor metal layer to form a core/metal layer/sheath composite; and
co-deforming the composite under conditions, which do not oxidize the predecessor metal.

70. The method of claim 69, wherein the predecessor metal is in the form of a foil.

72. The method of claim 69, wherein the predecessor metal is deposited by electroplating or electrodeposition.

73. The method of claim 69, wherein the core is solid.

74. The method of claim 67, wherein the core is hollow.

75. The method of claim 66, wherein the composite is textured by a large reduction rolling on the order of 40-85% reduction in thickness.

76. The method of claim 66, wherein the composite is textured in a constrained rolling operation.

77. The method of claim 66, wherein the oxidized composite is subjected to a low strain deformation operation after oxidation of the predecessor metal in the range of 0-15% reduction in thickness, selected so that the physical integrity of the oxidized predecessor metal layer is not destroyed.

78. A former for use in a multistrand cable, comprising:
a flattened strip of resistive material or a predecessor thereto, said strip having curved edges.

79. A monofilament rod for use in preparing a multifilament oxide superconducting strand, comprising:
an oxide filament in a ductile metal matrix, said oxide comprising an oxide superconductor or precursor thereto and said matrix comprising a high resistivity layer or precursor thereto; and
wherein said rod comprises two opposing concentric curved surfaces connected by two substantially planar surfaces.

80. An oxide superconductor cable comprising:
a plurality of aspected strands planetary wound about a center former,
wherein the orientation of the aspected strands about the center former is substantially invariant and wherein the packing factor of the cable is greater than or equal to 75%

81. The cable of claim 80, wherein orientation of the aspected strand is determined with respect to an axis of the oxide superconductor phase.

82. The cable of claim 80, wherein orientation of the aspected strand is determined with respect to the flat surface of the aspected strand.

83. The cable of claim 80, wherein the cable packing factor is greater than or equal to 80%.

84. The cable of claim 80, wherein the cable packing factor is in the range of about 80-90%.

85. A method of making an oxide superconductor cable, comprising:
transposing a plurality of oxide superconductor strands about a center former, wherein the plurality of oxide superconductor strands are prebent in an amplitude and at a wavelength that conforms with the geometry of the former and selected strand lay pitch.
